(19) United States
(12) Patent Application Publication
(10) Pub. No.: US 2019/0394494 A1
(43) Pub. Date: Dec. 26, 2019

(54) IMAGE PROCESSING APPARATUS AND METHOD

(71) Applicant: SONY CORPORATION, TOKYO (JP)

(72) Inventor: HIRONARI SAKURAI, KANAGAWA (JP)

(21) Appl. No.: 16/480,608

(22) PCT Filed: Feb. 6, 2018
(86) PCT No.: PCT/JP2018/003896

§ 371 Date: Jul. 24, 2019

(30) Foreign Application Priority Data
Feb. 20, 2017 (JP) 2017-029342

(51) Int. Cl. H04N 19/88; H04N 19/70

(52) U.S. Cl. CPC H04N 19/88; H04N 19/70

(57) ABSTRACT

The present disclosure relates to image processing apparatus and method that can realize the same GOP structure as AVC in a case of field coding. Fields in each GOP of interlaced images input in a reproduction order are rearranged to arrange the fields in a decoding order in order of an I picture, a leading picture that precedes the I picture in the reproduction order, and a trailing picture that follows the I picture in the reproduction order, and the fields rearranged in the decoding order are encoded. The present disclosure can be applied to, for example, an image processing apparatus, an image encoding apparatus, an image decoding apparatus, or the like.

### TECHNICAL FIELD

The present disclosure relates to image processing apparatus and method, and particularly, to image processing apparatus and method that can realize the same GOP structure as AVC in a case of field coding.

### BACKGROUND ART

In recent years, to further improve the encoding efficiency from MPEG-4 Part 10 (Advanced Video Coding, hereinafter referred to as AVC), the JCTVC (Joint Collaboration Team-Video Coding) that is a joint standards organization of the ITU-T (International Telecommunication Union Telecommunication Standardization Sector) and the ISO/IEC (International Organization for Standardization/International Electrotechnical Commission) is standardizing an encoding system called HEVC (High Efficiency Video Coding) (for example, see NPL 1).

Information regarding random access can be provided by nal_unit_type in the HEVC, unlike in the AVC. A constraint is set for the nal_unit_type in the HEVC to guarantee the random access.

### CITATION LIST

### Non Patent Literature

[NPL 1]

ITU-T, “SERIES H: AUDIOVISUAL AND MULTIMEDIA SYSTEMS Infrastructure of audiovisual services. Coding of moving video High efficiency video coding,” ITU-T H.265 (V3), Apr. 29, 2015

### SUMMARY

### Technical Problem

However, the constraint set for the NAL unit type (nal_unit_type) is on the basis of frame coding, and a GOP (Group Of Picture) structure that can be used in the AVC may not be realized in the case of the field coding.

The present disclosure has been made in view of the circumstances, and the present disclosure can realize the same GOP structure as the AVC in the case of the field coding.

### Solution to Problem

An aspect of the present technique provides an image processing apparatus including: a rearrangement unit that rearranges fields in each GOP (Group Of Picture) of interlaced images input in a reproduction order to arrange the fields in a decoding order in order of an I picture, a leading picture that precedes the I picture in the reproduction order, and a trailing picture that follows the I picture in the reproduction order; and an encoding unit that encodes the fields rearranged in the decoding order by the rearrangement unit.

The rearrangement unit can rearrange a P picture of a bottom field paired with the I picture of a top field in the reproduction order such that the P picture follows the leading picture.

The image processing apparatus can further include a setting unit that sets nal_unit_type of each of the fields.

The setting unit can set the I picture as a trailing picture in a second or subsequent GOP.

The setting unit can set the I picture in a bottom field, set the P picture, which follows the I picture in the decoding order, in a top field paired with the I picture, and set the P picture as a leading picture in a second or subsequent GOP.

The rearrangement unit can eliminate the leading picture of a second or subsequent GOP when the rearrangement unit rearranges the fields in the decoding order.

The image processing apparatus can further include: an orthogonal transformation unit that performs an orthogonal transformation of the fields rearranged in the decoding order by the rearrangement unit; and a quantization unit that quantizes an orthogonal transformation coefficient obtained by the orthogonal transformation unit, in which the encoding unit is configured to encode a quantization coefficient obtained by the quantization unit.

The image processing apparatus can further include: a prediction unit that generates a predicted image of the fields; and a computation unit that subtracts the predicted image generated by the prediction unit from the fields rearranged in the decoding order by the rearrangement unit to generate residual data, in which the orthogonal transformation unit is configured to perform an orthogonal transformation of the residual data obtained by the computation unit.

The rearrangement unit and the encoding unit can use methods in compliance with ITU-T H.265|ISO/IEC 23008-2 High Efficiency Video Coding to execute the respective processes.

The aspect of the present technique provides an image processing method including: rearranging fields in each GOP (Group Of Picture) of interlaced images input in a reproduction order to arrange the fields in a decoding order in order of an I picture, a leading picture that precedes the I picture in the reproduction order, and a trailing picture that follows the I picture in the reproduction order; and encoding the fields rearranged in the decoding order.

Another aspect of the present technique provides an image processing apparatus including: a setting unit that sets nal_unit_type of each of fields in each GOP (Group Of Picture) of interlaced images input in a reproduction order and that sets, for a P picture of a field paired with an I picture, nal_unit_type indicative of a picture paired with the I picture; and an encoding unit that encodes each of the fields provided with the nal_unit_type set by the setting unit.

The setting unit can set the nal_unit_type of a P picture of a field paired with an IDR picture to IDR_PAIR_W_RADL or IDR_PAIR_N_LP.

The setting unit can set the nal_unit_type of a P picture of a field paired with a CRA picture to CRA_PAIR_NUT.

The setting unit can set the nal_unit_type of a P picture of a field paired with a BLA picture to BLA_PAIR_W_LP, BLA_PAIR_W_RADL, or BLA_PAIR_N_LP.

The image processing apparatus can further include a rearrangement unit that rearranges, in a decoding order, each of the fields in the reproduction order provided with the nal_unit_type set by the setting unit, in which the encoding unit is configured to encode the fields rearranged in the decoding order by the rearrangement unit.

The rearrangement unit can rearrange the P picture provided with the nal_unit_type indicative of the picture paired with the I picture set by the setting unit such that the P picture precedes the leading picture that precedes the I picture in the reproduction order.

The image processing apparatus can further include: an orthogonal transformation unit that performs an orthogonal transformation of each of the fields provided with the nal_unit_type set by the setting unit; and a quantization unit that quantizes an orthogonal transformation coefficient obtained by the orthogonal transformation unit, in which the encoding unit is configured to encode a quantization coefficient obtained by the quantization unit.

The image processing apparatus can further include: a prediction unit that generates a predicted image of the fields; and a computation unit that subtracts the predicted image generated by the prediction unit from the fields provided with the nal_unit_type set by the setting unit to generate residual data, in which the orthogonal transformation unit is configured to perform an orthogonal transformation of the residual data obtained by the computation unit.

The setting unit and the encoding unit can use methods in compliance with ITU-T H.265|ISO/IEC 23008-2 High Efficiency Video Coding to execute the respective processes.

The other aspect of the present technique provides an image processing method including: setting nal_unit_type of each of fields in each GOP (Group Of Picture) of interlaced images input in a reproduction order and setting, for a P picture of a field paired with an I picture, nal_unit_type indicative of a picture paired with the I picture; and encoding each of the fields provided with the nal_unit_type.

In the image processing apparatus and method according to an aspect of the present technique, the fields in each GOP (Group Of Picture) of the interlaced images input in the reproduction order are rearranged to arrange the fields in the decoding order in order of the I picture, the leading picture that precedes the I picture in the reproduction order, and the trailing picture that follows the I picture in the reproduction order, and the fields rearranged in the decoding order are encoded.

In the image processing apparatus and method according to another aspect of the present technique, the nal_unit_type of each of the fields is set in each GOP (Group Of Picture) of the interlaced images input in the reproduction order, the nal_unit_type indicative of the picture paired with the I picture is set for the P picture of the field paired with the I picture, and each of the fields provided with the nal_unit_type is encoded.

### Advantageous Effect of Invention

According to the present disclosure, an image can be processed. Particularly, the same GOP structure as the AVC can be realized in the case of field coding.

### BRIEF DESCRIPTION OF DRAWINGS

FIG. 1 is a diagram illustrating an example of a GOP structure in field coding of AVC.

FIG. 2 is a diagram illustrating NAL unit types.

FIG. 3 is a diagram describing NAL unit types regarding random access.

FIG. 4 is a diagram describing a reproduction order.

FIG. 5 is a diagram illustrating an example of a GOP structure in field coding of HEVC.

FIG. 6 is a block diagram illustrating a main configuration example of an image encoding apparatus.

FIG. 7 is a block diagram illustrating a main configuration example of a preprocessing unit.

FIG. 8 is a flow chart describing an example of a flow of an image encoding process.

FIG. 9 is a flow chart describing an example of a flow of preprocessing.

FIG. 10 is a diagram illustrating an example of a GOP structure of field coding.

FIG. 11 is a block diagram illustrating a main configuration example of an image decoding apparatus.

FIG. 12 is a flow chart describing an example of a flow of an image decoding process.

FIG. 13 is a diagram illustrating another example of the GOP structure of the field coding.

FIG. 14 is a diagram illustrating yet another example of the GOP structure of the field coding.

FIG. 15 is a diagram illustrating yet another example of the GOP structure of the field coding.

FIG. 16 is a diagram illustrating yet another example of the GOP structure of the field coding.

FIG. 17 is a diagram illustrating yet another example of the GOP structure of the field coding.

FIG. 18 is a diagram illustrating an example of NAL unit types.

FIG. 19 is a diagram illustrating yet another example of the GOP structure of the field coding.

FIG. 20 is a block diagram illustrating a main configuration example of a computer.

FIG. 21 is a block diagram illustrating an example of a schematic configuration of a television apparatus.

FIG. 22 is a block diagram illustrating an example of a schematic configuration of a mobile phone.

FIG. 23 is a block diagram illustrating an example of a schematic configuration of a recording/reproducing apparatus.

FIG. 24 is a block diagram illustrating an example of a schematic configuration of an imaging apparatus.

FIG. 25 is a block diagram illustrating an example of a schematic configuration of a video set.

FIG. 26 is a block diagram illustrating an example of a schematic configuration of a video processor.

FIG. 27 is a block diagram illustrating another example of the schematic configuration of the video processor.

FIG. 28 is a block diagram illustrating an example of a schematic configuration of a network system.

### DESCRIPTION OF EMBODIMENTS

Hereinafter, modes for carrying out the present disclosure (hereinafter, referred to as embodiments) will be described. Note that the embodiments will be described in the following order.

1. GOP Structure of Field Coding

2. First Embodiment (Decoding Order of P Picture)

3. Second Embodiment (I Picture of Bottom Field)

4. Third Embodiment (Elimination of Leading Picture)

5. Fourth Embodiment (Setting of NAL Unit Type)

6. Fifth Embodiment (Etc.)

### 1. GOP Structure of Field Coding

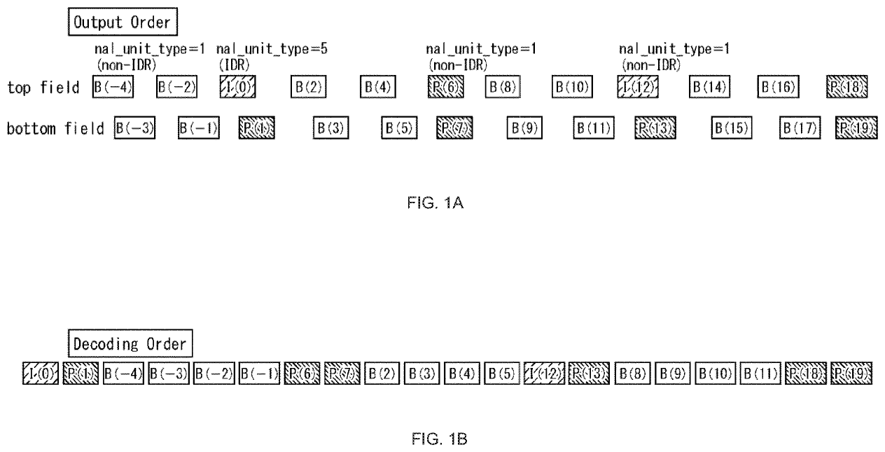

In the past, in MPEG-4 Part 10 (Advanced Video Coding, hereinafter, referred to as AVC), a GOP (Group Of Picture) structure and a reference structure as illustrated in FIG. 1 have been possible in a case of field coding. A of FIG. 1 illustrates a reproduction order (display order) of the GOP structure, and B of FIG. 1 illustrates a decoding order (encoding order). The GOP structure is used in, for example, XAVC (registered trademark), AVCHD (registered trademark), and the like.

In the AVC, a NAL unit type 5 (nal_unit_type=5) is allocated to IDR (Instantaneous Decoding Refresh) pictures, and a NAL unit type 1 (nal_unit_type 1 (non IDR)) is allocated to other pictures.

In recent years, to further improve the encoding efficiency from MPEG-4 Part 10 (Advanced Video Coding, hereinafter, referred to as AVC), the JCTVC (Joint Collaboration Team-Video Coding) that is a joint standards organization of the ITU-T (International Telecommunication Union Telecommunication Standardization Sector) and the ISO/IEC (International Organization for Standardization/International Electrotechnical Commission) is standardizing an encoding system called HEVC (High Efficiency Video Coding).

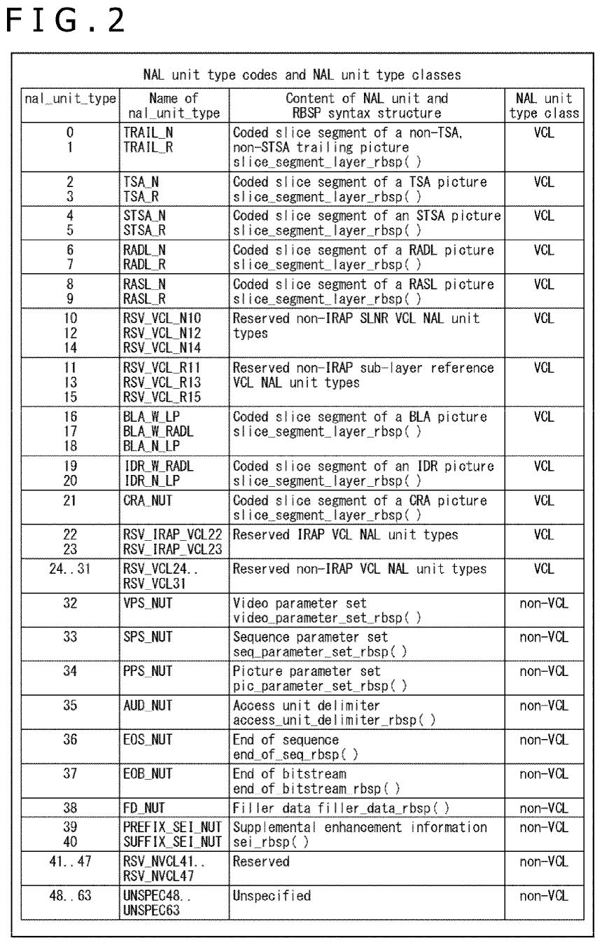

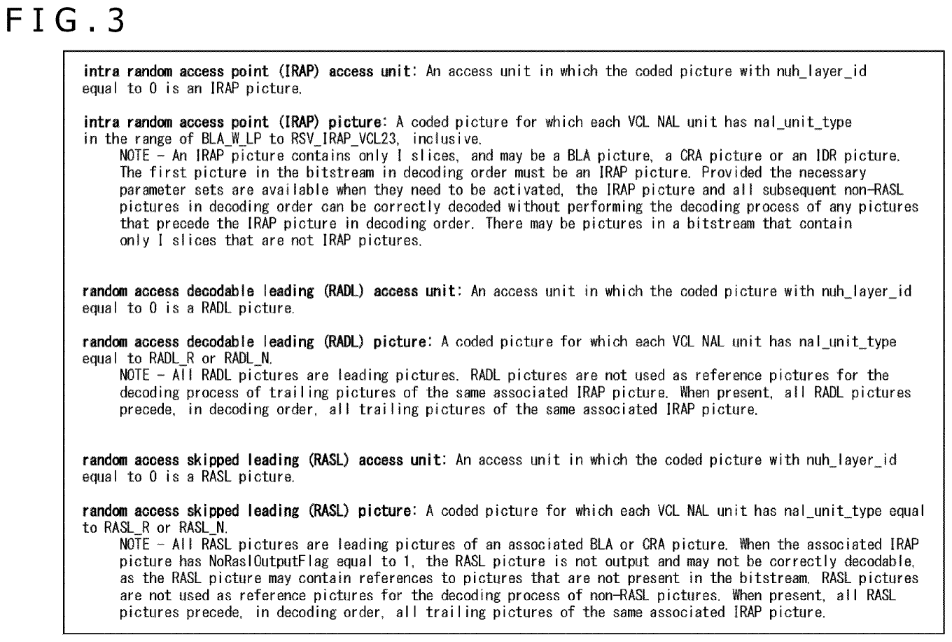

Information regarding random access can be provided by the NAL unit type (nal_unit_type) in the HEVC, unlike in the AVC. For example, various NAL unit types as in a table illustrated in FIG. 2 are prepared for the HEVC. In addition, NAL unit types, such as IRAP, RADL, and RASL, that enable random access are prepared as illustrated in FIG. 3.

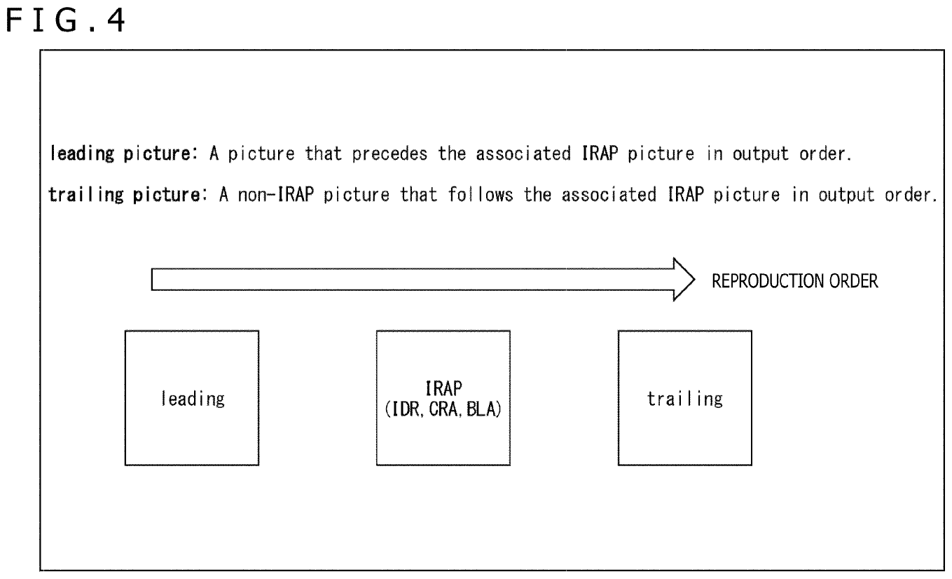

To guarantee the random access, a constraint is set for the NAL unit type in the HEVC. For example, as illustrated in FIG. 4, the picture reproduced before the associated IRAP picture in the reproduction order will be referred to as a leading picture, and the picture reproduced after the associated IRAP picture will be referred to as a trailing picture. For the leading picture and the trailing picture, there is a constraint that the leading picture needs to be decoded before the trailing picture in the decoding order.

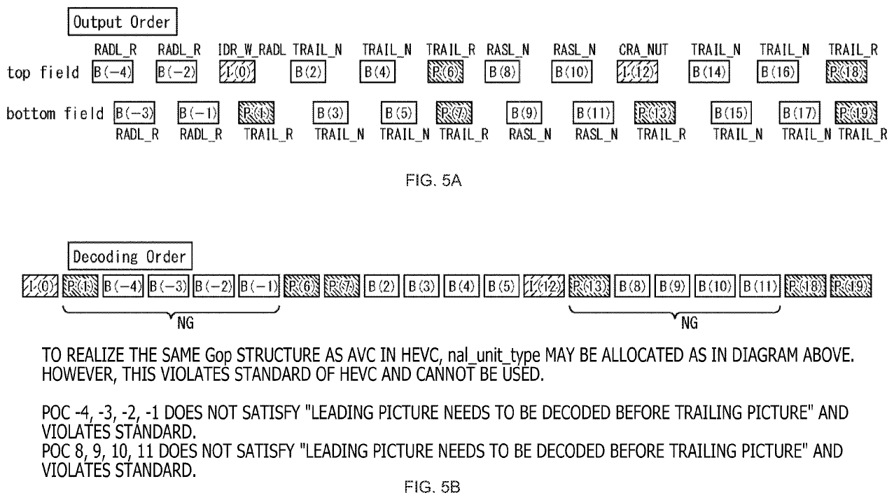

FIG. 5 illustrates an example of a case in which the GOP structure of FIG. 1 is applied to the HEVC. A of FIG. 5 illustrates a reproduction order (display order) of the GOP structure, and B of FIG. 5 illustrates a decoding order (encoding order). As illustrated in A of FIG. 5, in the reproduction order, the P picture (P(1)) is set in a bottom field paired with a top field set for the I picture (I(0), nal_unit_type=IDR_W_RADL). That is, the P picture (P(1)) is a trailing picture (nal_unit_type=TRAIL_R). In this case, when the decoding order is as in the AVC, the P picture (P(1)) is decoded after the I picture (I(0)), and then the leading pictures (B(−4) to B(−1)) are decoded as illustrated in B of FIG. 5.

However, in this case, the trailing picture (P(1)) is decoded before the leading pictures (B(−4) to B(−1)). Therefore, the constraint is not satisfied, and this violates the standard of the HEVC. That is, the GOP structure cannot be realized in the HEVC. Note that in the case of FIG. 5, P(13) and B(8) to B(11) similarly violate the standard.

### 2. First Embodiment

### <Changing Decoding Order of P Picture>

Therefore, in each GOP (Group Of Picture) of interlaced images input in the reproduction order, the fields are rearranged in a decoding order for arrangement in order of the I picture, the leading picture that precedes the I picture in the reproduction order, and the trailing picture that follows the I picture in the reproduction order. More specifically, the P picture of a bottom field paired with the I picture of a top field in the reproduction order is rearranged after the leading picture.

### <Image Encoding Apparatus>

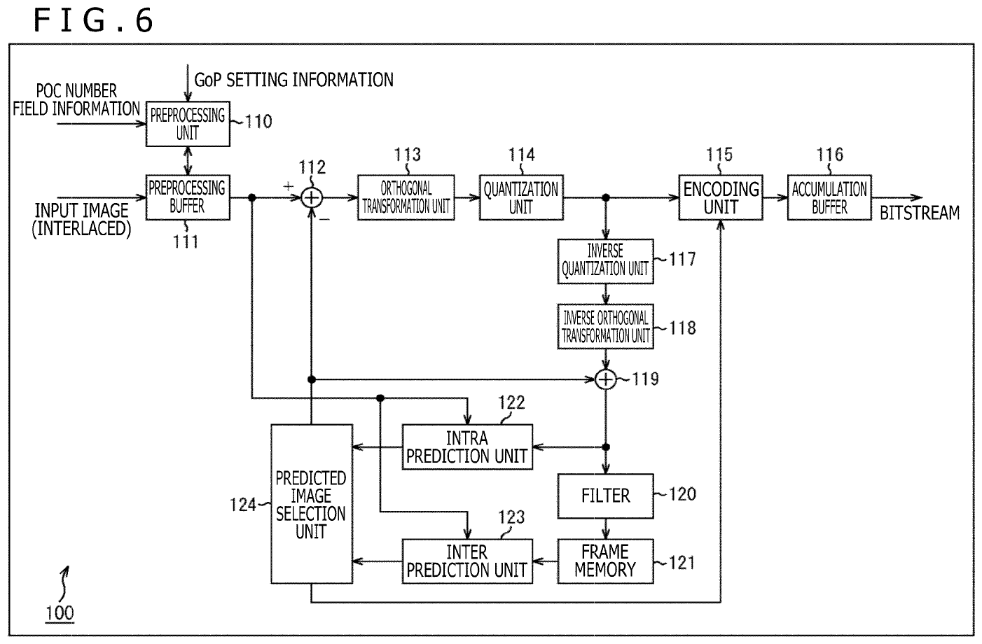

FIG. 6 is a block diagram illustrating an example of a configuration of an image encoding apparatus as a mode of an image processing apparatus according to the present technique.

An image encoding apparatus 100 illustrated in FIG. 6 is an apparatus that uses, for example, a method in compliance with the HEVC (ITU-T H.265|ISO/IEC 23008-2 High Efficiency Video Coding) to encode image data of moving images. Although the scan system of the moving images input to the image encoding apparatus 100 may be progressive or interlaced, it is assumed below that interlaced moving images are input to the image encoding apparatus 100.

Note that FIG. 6 illustrates main processing units, flows of data, and the like, and everything may not be illustrated in FIG. 6. That is, in the image encoding apparatus 100, there may be processing units not illustrated as blocks in FIG. 6, or there may be processes or flows of data not illustrated as arrows or the like in FIG. 6.

As illustrated in FIG. 6, the image encoding apparatus 100 includes a preprocessing unit 110, a preprocessing buffer 111, a computation unit 112, an orthogonal transformation unit 113, a quantization unit 114, an encoding unit 115, and an accumulation buffer 116. The image encoding apparatus 100 also includes an inverse quantization unit 117, an inverse orthogonal transformation unit 118, a computation unit 119, a filter 120, a frame memory 121, an intra prediction unit 122, an inter prediction unit 123, and a predicted image selection unit 124.

Each field (input image) of the moving images is input to the image encoding apparatus 100 in the reproduction order (display order). The preprocessing buffer 111 stores each input image in the reproduction order (display order). The preprocessing unit 110 sets the NAL unit type (nal_unit_type) to the input images stored in the preprocessing buffer 111 and rearranges the input images in the decoding order (encoding order). The computation unit 112 executes a process regarding subtraction of the input image read from the preprocessing buffer 111 in the decoding order and a predicted image. The orthogonal transformation unit 113 executes a process regarding an orthogonal transformation of residual information (also referred to as residual data) that is a difference between the input image and the predicted image obtained by the computation unit 112. The quantization unit 114 executes a process regarding quantization of an orthogonal transformation coefficient obtained by the orthogonal transformation unit 113.

The encoding unit 115 executes a process regarding encoding of a quantization coefficient obtained by the quantization unit 114. In addition, the encoding unit 115 executes a process regarding encoding of information (metadata) regarding the input image, such as information regarding an optimal prediction mode and information regarding the NAL unit type. The accumulation buffer 116 temporarily holds the encoded data obtained by the encoding unit 115. The accumulation buffer 116 outputs the held encoded data as, for example, a bitstream to the outside of the image encoding apparatus 100 at predetermined timing. For example, the encoded data is transmitted to the decoding side through an arbitrary recording medium, an arbitrary transmission medium, an arbitrary information processing apparatus, or the like. That is, the accumulation buffer 116 is also a transmission unit that transmits encoded data.

The inverse quantization unit 117 executes a process regarding inverse quantization of the quantization coefficient obtained by the quantization unit 114. The inverse quantization is an opposite process of the quantization performed by the quantization unit 114. The inverse orthogonal transformation unit 118 executes a process regarding an inverse orthogonal transformation of the orthogonal transformation coefficient obtained by the inverse quantization unit 117. The inverse orthogonal transformation is an opposite process of the orthogonal transformation performed by the orthogonal transformation unit 113. The computation unit 119 executes a process regarding addition of the residual data and the predicted image obtained by the inverse orthogonal transformation unit 118. The filter 120 executes a process regarding a filtering process of a locally reconstructed image (also referred to as reconstructed image) obtained by the computation unit 119. The frame memory 121 stores a filtering process result (also referred to as decoded image) obtained by the filter 120 in a storage area of the frame memory 121.

The intra prediction unit 122 executes a process regarding using the reconstructed image obtained by the computation unit 119 and the input images read in the decoding order from the preprocessing buffer 111 to generate a predicted image (intra prediction). The inter prediction unit 123 executes a process regarding using the decoded image read from the frame memory 121 and the input images read in the decoding order from the preprocessing buffer 111 to generate a predicted image (inter prediction). The predicted image selection unit 124 executes a process regarding selection of any one of the predicted image obtained by the intra prediction unit 122 and the predicted image obtained by the inter prediction unit 123.

### <Preprocessing Unit>

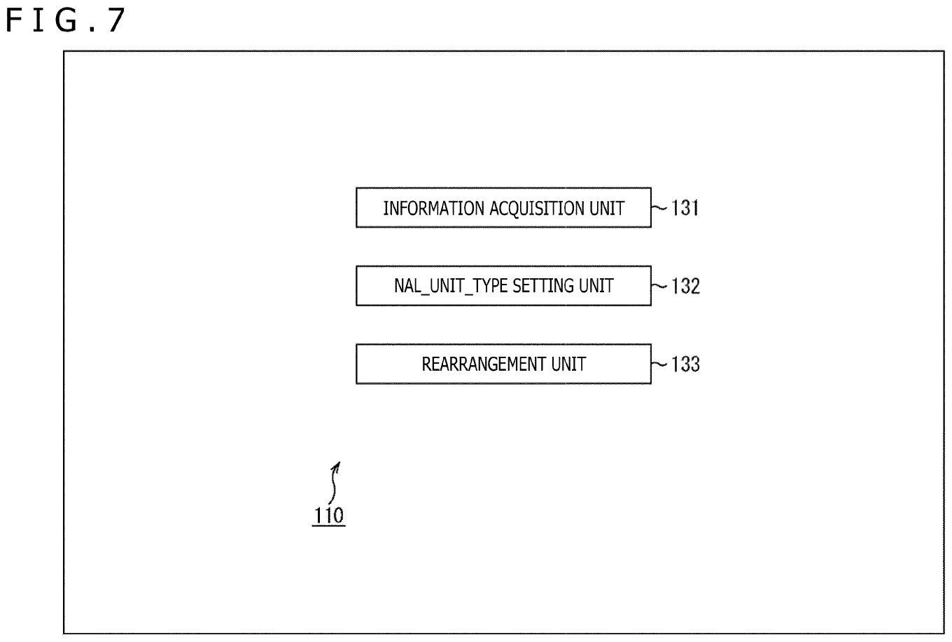

FIG. 7 is a block diagram illustrating a main configuration example of the preprocessing unit 110. As illustrated in FIG. 7, the preprocessing unit 110 includes an information acquisition unit 131, a NAL_UNIT_TYPE setting unit 132, and a rearrangement unit 133.

The information acquisition unit 131 executes a process regarding acquisition of information regarding the input image, such as a POC (Picture Order Count) number, field information, and GOP setting information. The NAL_UNIT_TYPE setting unit 132 executes a process regarding setting of the NAL unit type (nal_unit_type) for each input image (frame or field). The rearrangement unit 133 executes a process regarding rearrangement of the input images stored in the reproduction order (display order) in the preprocessing buffer 111 to arrange the input images in the decoding order (encoding order).

### <Flow of Image Encoding Process>

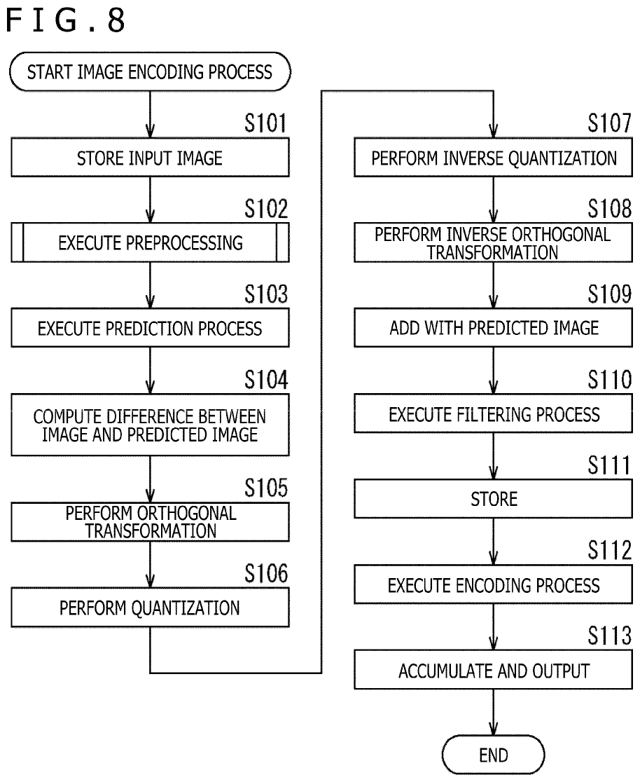

Next, the process executed by the image encoding apparatus 100 will be described. First, an example of a flow of the image encoding process executed by the image encoding apparatus 100 will be described with reference to a flow chart of FIG. 8.

Once the image encoding process is started, the preprocessing buffer 111 sequentially stores and accumulates the input images (fields) input in the reproduction order (display order) in step S101. Once the input images equivalent to a predetermined number of fields are accumulated in the preprocessing buffer 111, the preprocessing unit 110 applies preprocessing to the input images stored in the preprocessing buffer 111 in step S102. Details of the preprocessing will be described later.

Once the preprocessing is finished, each input image of the preprocessing buffer 111 is read in the decoding order (encoding order) and supplied to the computation unit 112, the intra prediction unit 122, and the inter prediction unit 123. In addition, the information (such as metadata) regarding each input image is supplied to predetermined processing units in the image encoding apparatus 100 that require the information.

In step S103, the intra prediction unit 122, the inter prediction unit 123, and the predicted image selection unit 124 execute a prediction process to generate a predicted image or the like of an optimal prediction mode. For example, the intra prediction unit 122 uses the input image supplied from the preprocessing buffer 111 and the reconstructed image supplied as a reference image from the computation unit 119 (that is, pixel values of processed blocks in the picture to be processed) to perform intra prediction (prediction in screen) to generate a predicted image (intra predicted image). For example, the intra prediction unit 122 performs the intra prediction in a plurality of prepared intra prediction modes. The intra prediction unit 122 generates predicted images in all of candidate intra prediction modes and selects an optimal mode. Once the intra prediction unit 122 selects the optimal intra prediction mode, the intra prediction unit 122 supplies intra prediction mode information or the like that is information regarding the intra prediction, such as the predicted image generated in the optimal intra prediction mode and an index indicating the optimal intra prediction mode, as information regarding prediction results to the predicted image selection unit 124.

The inter prediction unit 123 uses the input image supplied from the preprocessing buffer 111 and the local decoded image supplied as a reference image from the frame memory 121 to execute an inter prediction process (motion prediction process and compensation process) to generate a predicted image (inter predicted image). For example, the inter prediction unit 123 the inter prediction unit 123 performs the inter prediction in a plurality of prepared inter prediction modes. The inter prediction unit 123 generates predicted images in all of candidate inter prediction modes and selects an optimal mode. Once the inter prediction unit 123 selects the optimal inter prediction mode, the inter prediction unit 123 supplies inter prediction mode information or the like that is information regarding the inter prediction, such as the predicted image generated in the optimal inter prediction mode, an index indicating the optimal inter prediction mode, and motion information, as information regarding prediction results to the predicted image selection unit 124.

The predicted image selection unit 124 acquires the information regarding the prediction results from the intra prediction unit 122 and the inter prediction unit 123. The predicted image selection unit 124 selects any one of the intra prediction mode (optimal) and the inter prediction mode (optimal) as an optimal prediction mode. The predicted image selection unit 124 supplies the predicted image of the selected mode to the computation unit 112 and the computation unit 119. In addition, the predicted image selection unit 124 supplies part or all of the information regarding the selected prediction results as information regarding the optimal prediction mode to the encoding unit 115 to store the information in the encoded data.

Once the prediction process is finished, the computation unit 112 in step S104 computes the difference between the input image preprocessed in step S102 and read from the preprocessing buffer 111 and the predicted image of the optimal mode generated in the process of step S103 and supplied from the predicted image selection unit 124. That is, the computation unit 112 generates residual data of the input image and the predicted image. The amount of data of the residual data obtained in this way is smaller than the amount of data of the original image data. Therefore, the amount of data can be compressed as compared to the case of encoding the image without the computation. The computation unit 112 supplies the obtained residual data to the orthogonal transformation unit 113.

In step S105, the orthogonal transformation unit 113 uses a predetermined method to perform an orthogonal transformation of the residual data generated in the process of step S104 and supplied from the computation unit 112 to obtain an orthogonal transformation coefficient of the residual data. The orthogonal transformation unit 113 supplies the orthogonal transformation coefficient to the quantization unit 114.

In step S106, the quantization unit 114 quantizes the orthogonal transformation coefficient of the residual data obtained in the process of step S105 and supplied from the orthogonal transformation unit 113 to obtain a quantization coefficient of the orthogonal transformation coefficient. The quantization unit 114 sets a quantization parameter according to, for example, a target encoding rate (target bitrate) and uses the quantization parameter or the like to perform the quantization. The quantization unit 114 supplies the quantization coefficient obtained by the quantization to the encoding unit 115 and the inverse quantization unit 117.

In step S107, the inverse quantization unit 117 performs inverse quantization of the quantization coefficient of the orthogonal transformation coefficient obtained in the process of step S106 and supplied from the quantization unit 114 according to characteristics corresponding to the characteristics of the quantization in step S106 to obtain an orthogonal transformation coefficient. The inverse quantization unit 117 supplies the orthogonal transformation coefficient to the inverse orthogonal transformation unit 118.

In step S108, the inverse orthogonal transformation unit 118 uses a method corresponding to the orthogonal transformation of step S105 to perform an inverse orthogonal transformation of the orthogonal transformation coefficient obtained in the process of step S107 and supplied from the inverse quantization unit 117 to obtain restored residual data. The inverse orthogonal transformation unit 118 supplies the restored residual data to the computation unit 119.

In step S109, the computation unit 119 adds the predicted image obtained in the process of step S103 and supplied from the predicted image selection unit 124 to the restored residual data obtained in the process of step S108 and supplied from the inverse orthogonal transformation unit 118 to obtain a locally reconstructed image (also referred to as reconstructed image). The computation unit 119 supplies the obtained reconstructed image to the filter 120. In addition, the computation unit 119 also supplies the reconstructed image to the intra prediction unit 122 for use in the prediction process of step S103.

In step S110, the filter 120 applies a filtering process, such as a deblocking filter, to the image data of the reconstructed image obtained in the process of step S109 and supplied from the computation unit 119. The filter 120 supplies the filtering process result (also referred to as decoded image) to the frame memory 121.

In step S111, the frame memory 121 stores the locally decoded image obtained in the process of step S110 and supplied from the filter 120 in a storage area of the frame memory 121. In addition, the frame memory 121 supplies the stored local decoded image as a reference image to the inter prediction unit 123 at predetermined timing for use in the prediction process of step S103.

In step S112, the encoding unit 115 encodes the quantization coefficient obtained in the process of step S106 and supplied from the quantization unit 114. For example, the encoding unit 115 applies CABAC (Context-based Adaptive Binary Arithmetic Code) to the quantization coefficient to generate encoded data. In addition, the encoding unit 115 encodes the metadata generated in the preprocessing of step S102 and adds the metadata to the encoded data. Furthermore, the encoding unit 115 also appropriately encodes the information regarding the quantization, the information regarding the prediction, and the like and adds the information to the encoded data. In this way, the encoding unit 115 encodes the information regarding the image to generate encoded data. The encoding unit 115 supplies the obtained encoded data to the accumulation buffer 116.

In step S113, the accumulation buffer 116 accumulates the encoded data and the like obtained in the process of step S112 and supplied from the encoding unit 115. The encoded data and the like accumulated in the accumulation buffer 116 are appropriately read as, for example, bitstreams and transmitted to the decoding side through a transmission path or a recording medium.

Once the process of step S113 is finished, the image encoding process ends.

Note that the units of processing in the processes are arbitrary and may not be the same. Therefore, the process of each step can be appropriately executed in parallel with the process or the like of another step, or the processing order can be switched to execute the processes.

### <Flow of Preprocessing>

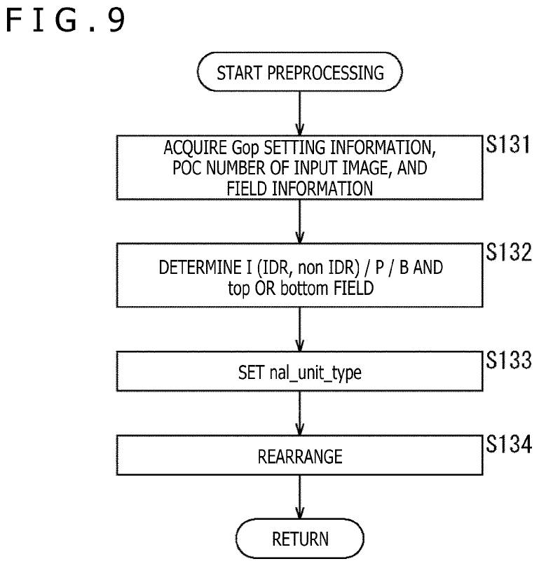

Next, an example of the flow of the preprocessing executed in step S102 of FIG. 8 will be described with reference to a flow chart of FIG. 9. Once the preprocessing is started, the information acquisition unit 131 acquires the GOP setting information, the POC number of the input image, the field information, and the like supplied from the outside in step S131.

In step S132, the NAL_UNIT_TYPE setting unit 132 determines which one of the I picture, the P picture, and the B picture each picture stored in the preprocessing buffer 111 is based on the information acquired in the process of step S131. In a case where the NAL_UNIT_TYPE setting unit 132 determines whether the picture is the I picture, the NAL_UNIT_TYPE setting unit 132 further determines whether the I picture is an IDR picture (non IDR). The NAL_UNIT_TYPE setting unit 132 also determines which one of the top field and the bottom field each picture stored in the preprocessing buffer 111 is.

In step S133, the NAL_UNIT_TYPE setting unit 132 sets the NAL unit type (nal_unit_type) of each picture based on the determination result of step S132 and the information acquired in step S131.

In step S134, the rearrangement unit 133 rearranges the pictures arranged in the reproduction order stored in the preprocessing buffer 111 based on the information acquired in the step S131 to arrange the pictures in the decoding order.

Once the process of step S134 is finished, the preprocessing ends, and the process returns to FIG. 8.

### <Changing Decoding Order of P Picture>

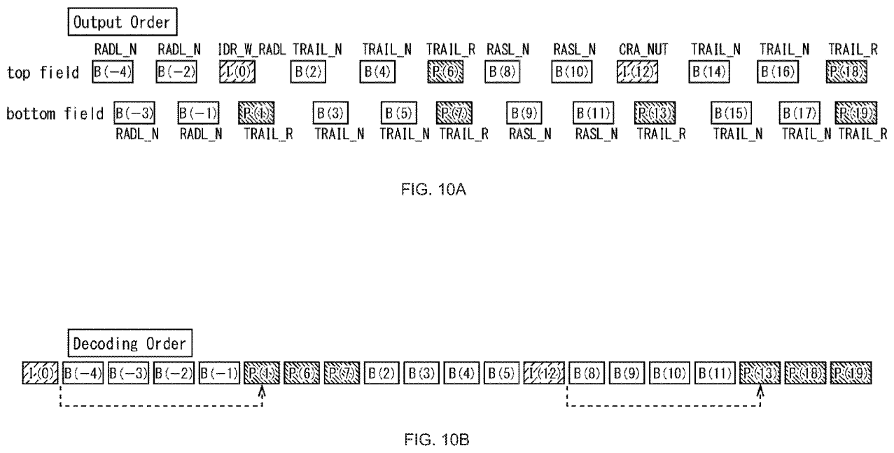

In the preprocessing, the NAL_UNIT_TYPE setting unit 132 sets the NAL unit type of each picture as in the case of the AVC, that is, as in the case of A of FIG. 5, as illustrated in A of FIG. 10. However, in this case, the rearrangement unit 133 rearranges the fields in the decoding order for arrangement in order of the I picture, the leading pictures that precede the I picture in the reproduction order, and the trailing picture that follows the I picture in the reproduction order as illustrated in B of FIG. 10. More specifically, the rearrangement unit 133 rearranges the P picture of a bottom field paired with the I picture of a top field in the reproduction order such that the P picture follows the leading pictures. For example, in B of FIG. 10, P(1) that is a trailing picture of I(0) is rearranged such that P(1) follows B(−4) to B(−1) that are leading pictures (dotted arrow). Similarly, P(13) that is a trailing picture of I(12) is rearranged such that P(13) follows B(8) to B(11) that are leading pictures (dotted arrow).

The rearrangement in the decoding order satisfies the constraint of the HEVC that the “leading picture needs to be decoded before the trailing picture,” and the violation of the standard of the HEVC can be prevented. Therefore, the same GOP structure as the AVC can also be realized in the HEVC in the case of the field coding.

Note that in this way, the P picture not paired with the I picture can refer to not only the I picture, but also the P picture paired with the I picture. Therefore, the reduction in the prediction accuracy can be suppressed, and the reduction in the encoding efficiency can be suppressed. For example, P(6) and P(7) in A of FIG. 10 can refer to not only I(0), but also P(1). Similarly, P(18) and P(19) can refer to not only I (12), but also P(13).

Furthermore, in this way, the violation of the standard of the HEVC can be prevented without eliminating the encoding and the decoding of the leading pictures. For example, B(−4) to B(−1) and B(8) to B(11) are also encoded and decoded in B of FIG. 10. This can suppress the reduction in the subjective image quality of the decoded images caused by the reduction in the number of fields. Furthermore, the NAL unit type (nal_unit_type) is basically similar to the case of FIG. 5, and the reduction in the random access can also be suppressed. In addition, the NAL unit type does not have to be newly defined, and this can facilitate the realization.

### <Image Decoding Apparatus>

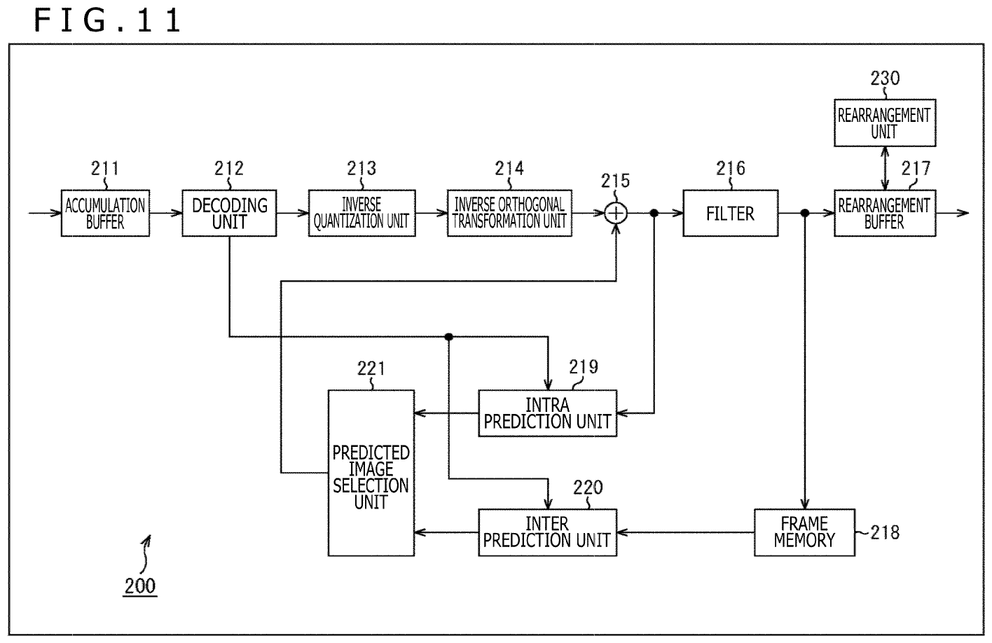

Next, decoding of the encoded data encoded as described above will be described. FIG. 11 is a block diagram illustrating an example of a configuration of an image decoding apparatus as a mode of an image processing apparatus according to the present technique. An image decoding apparatus 200 illustrated in FIG. 11 is an image decoding apparatus corresponding to the image encoding apparatus 100 of FIG. 6, and the image decoding apparatus 200 uses a decoding method corresponding to the encoding method to decode the encoded data generated by the image encoding apparatus 100. Note that FIG. 11 illustrates main processing units, flows of data, and the like, and everything may not be illustrated in FIG. 11. That is, in the image decoding apparatus 200, there may be processing units not illustrated as blocks in FIG. 11, and there may be processes or flows of data not illustrated as arrows or the like in FIG. 11.

As illustrated in FIG. 11, the image decoding apparatus 200 includes an accumulation buffer 211, a decoding unit 212, an inverse quantization unit 213, an inverse orthogonal transformation unit 214, a computation unit 215, a filter 216, a rearrangement buffer 217, a frame memory 218, an intra prediction unit 219, an inter prediction unit 220, and a predicted image selection unit 221. In addition, the image decoding apparatus 200 includes a rearrangement unit 230.

The encoded data generated by the image encoding apparatus 100 or the like is supplied as, for example, a bitstream or the like to the image decoding unit 200 through, for example, a transmission medium, a recording medium, or the like. The accumulation buffer 211 accumulates the encoded data and supplies the encoded data to the decoding unit 212 at predetermined timing.

The decoding unit 212 executes a process regarding decoding of the encoded data. For example, the decoding unit 212 decodes the encoded data to obtain information regarding the image including the quantization coefficient and the like. The inverse quantization unit 213 executes a process regarding inverse quantization of the quantization coefficient. The inverse quantization unit 213 corresponds to the quantization unit 114 (FIG. 6) and performs inverse quantization that is an opposite process of the quantization performed by the quantization unit 114. That is, the inverse quantization unit 213 executes a process basically similar to the inverse quantization unit 117 (FIG. 6).

The inverse orthogonal transformation unit 214 executes a process regarding an inverse orthogonal transformation of the orthogonal transformation coefficient. The inverse orthogonal transformation unit 214 corresponds to the orthogonal transformation unit 113 (FIG. 6) and performs an inverse orthogonal transformation that is an opposite process of the orthogonal transformation performed by the orthogonal transformation unit 113. That is, the inverse orthogonal transformation unit 214 executes a process basically similar to the inverse orthogonal transformation unit 118 (FIG. 6).

The computation unit 215 executes a process regarding addition of the residual data and the predicted image. The filter 216 executes a process regarding a filtering process of the reconstructed image. The rearrangement buffer 217 stores the decoded image that is a filtering process result. In addition, the rearrangement buffer 217 outputs the stored decoded image to the outside of the image decoding apparatus 200.

The frame memory 218 stores the decoded image that is a filtering process result. In addition, the frame memory 218 supplies the stored decoded image or the like to the inter prediction unit 220 at predetermined timing or based on a request from the outside such as from the inter prediction unit 220.

The intra prediction unit 219 executes a process regarding intra prediction. The inter prediction unit 220 executes a process regarding inter prediction. The predicted image selection unit 221 executes a process regarding selection of the predicted image.

### <Flow of Image Decoding Process>

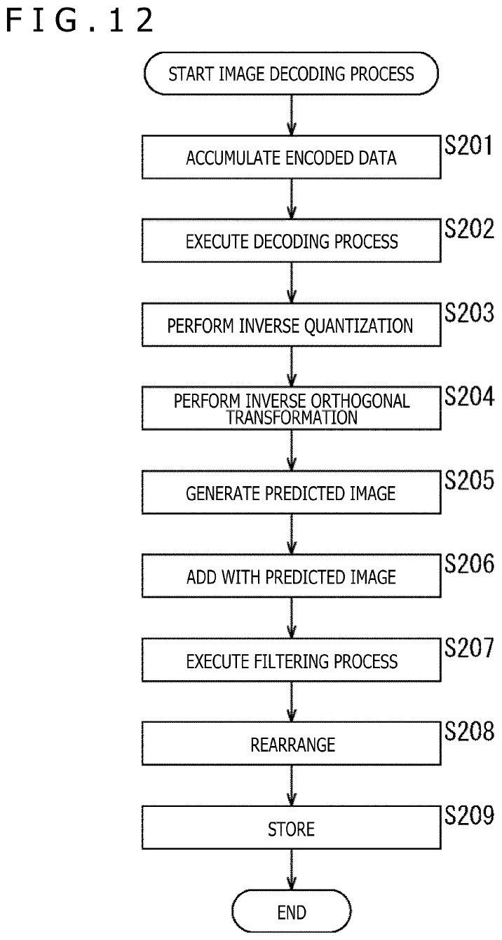

Next, an example of a flow of the image decoding process executed by the image decoding apparatus 200 will be described with reference to a flow chart of FIG. 12.

Once the image decoding process is started, the accumulation buffer 211 accumulates the encoded data supplied to the image decoding apparatus 200 in step S201. In step S202, the decoding unit 212 executes the decoding process. The decoding unit 212 uses a system (operation mode) corresponding to the encoding system of the encoding unit 115 of FIG. 6 to decode the encoded data supplied from the accumulation buffer 211. Once the decoding unit 212 decodes the encoded data and obtains a quantization coefficient, the decoding unit 212 supplies the quantization coefficient to the inverse quantization unit 213. In addition, once the decoding unit 212 decodes the encoded data and obtains information regarding the optimal prediction mode, the decoding unit 212 supplies the information to the intra prediction unit 219 or the inter prediction unit 220. For example, in the case where the intra prediction is performed, the decoding unit 212 supplies the information regarding the prediction result of the optimal prediction mode to the intra prediction unit 219. In addition, for example, the decoding unit 212 supplies the information regarding the prediction result of the optimal inter prediction mode to the inter prediction unit 220 in the case where the inter prediction is performed. Similarly, once the decoding unit 212 decodes the encoded data and obtains various types of information, the decoding unit 212 appropriately supplies the information to various processing units that require the information.

In step S203, the inverse quantization unit 213 performs inverse quantization of the quantization coefficient obtained in the process of step S202 and supplied from the decoding unit 212 to obtain an orthogonal transformation coefficient. The inverse quantization unit 213 uses a system corresponding to the quantization system of the quantization unit 114 of FIG. 6 (that is, system similar to the inverse quantization unit 117) to perform the inverse quantization. The inverse quantization unit 213 supplies the orthogonal transformation coefficient obtained by the inverse quantization to the inverse orthogonal transformation unit 214.

In step S204, the inverse orthogonal transformation unit 214 performs an inverse orthogonal transformation of the orthogonal transformation coefficient obtained in the process of step S203 and supplied from the inverse quantization unit 213 to obtain restored residual data. The inverse orthogonal transformation unit 214 uses a system corresponding to the orthogonal transformation system of the orthogonal transformation unit 113 of FIG. 6 (that is, system similar to the inverse orthogonal transformation unit 118) to perform the inverse orthogonal transformation. The inverse orthogonal transformation unit 214 supplies the residual data (restored residual data) obtained in the inverse orthogonal transformation process to the computation unit 215.

In step S205, the intra prediction unit 219, the inter prediction unit 220, and the predicted image selection unit 221 execute a prediction process in the prediction mode at the time of the encoding and generate a predicted image. For example, in the case where the block to be processed is a block for which the intra prediction is performed during the encoding, the intra prediction unit 219 generates an intra predicted image, and the predicted image selection unit 221 selects the intra predicted image as a predicted image. In addition, for example, in the case where the block to be processed is a block for which the inter prediction is performed during the encoding, the inter prediction unit 220 generates an inter predicted image, and the predicted image selection unit 221 selects the inter predicted image as a predicted image. The predicted image selection unit 221 supplies the selected predicted image to the computation unit 215.

In step S206, the computation unit 215 adds the predicted image obtained in the process of step S205 and supplied from the predicted image selection unit 221 to the restored residual data obtained in the process of step S204 and supplied from the inverse orthogonal transformation unit 214 to obtain a reconstructed image. The computation unit 215 supplies the reconstructed image to the filter 216. The computation unit 215 also supplies the reconstructed image to the intra prediction unit 219. The reconstructed image may be used for the intra prediction of a block to be processed later performed in the process of step S205.

In step S207, the filter 216 applies a filtering process, such as a deblocking filter, corresponding to the filtering process executed by the filter 120 of FIG. 6 to the reconstructed image obtained in the process of step S206 and supplied from the computation unit 215 to obtain a decoded image. The filter 216 supplies the obtained decoded image to the rearrangement buffer 217 and the frame memory 218.

In step S208, the rearrangement buffer 217 stores the decoded image obtained in the process of step S207 and supplied from the filter 216. That is, the rearrangement buffer 217 stores each of the decoded fields in the decoding order. The rearrangement unit 230 rearranges the decoded images in the decoding order stored in the rearrangement buffer 217 to arrange the decoded images in the reproduction order (display order). The rearrangement buffer 217 outputs the rearranged decoded images to the outside of the image decoding apparatus 200. That is, the rearrangement buffer 217 outputs the decoded images in the reproduction order.

In step S209, the frame memory 218 stores the decoded images obtained in the process of step S207. The decoded images may be used in the inter prediction of a block to be processed later performed in the process of step S205.

Once the process of step S209 is finished, the image decoding process ends.

Note that the units of processing in the processes are arbitrary, and the units of processing may not be the same. Therefore, the process of each step can be appropriately executed in parallel with the process or the like of another step, or the processing order can be switched to execute the processes.

That is, each processing unit of the image decoding apparatus 200 properly understands, properly decodes, and properly rearranges the NAL unit type and the arrangement order of each field set in the image encoding apparatus 100. Therefore, the same GOP structure as the AVC can be realized in the case of the field coding.

### <I Picture as Trailing Picture>

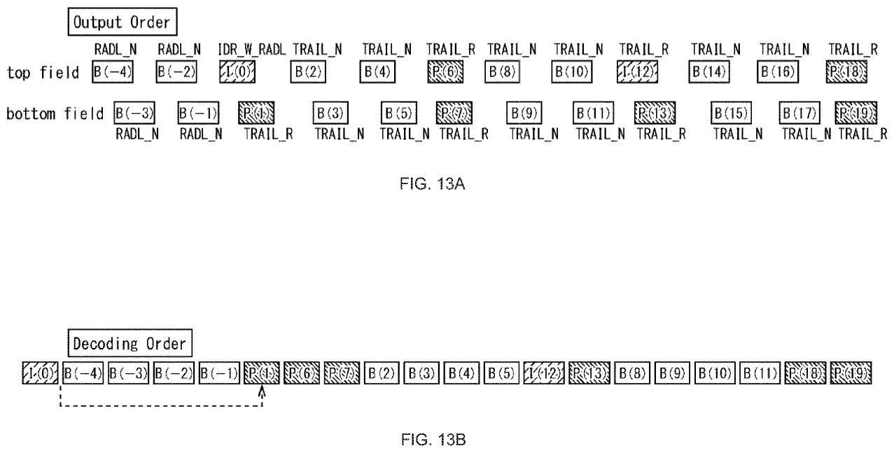

Note that, for example, as illustrated in A of FIG. 13, the I picture may be set as a trailing picture in a second or subsequent GOP. For example, in the case of A of FIG. 13, the NAL_UNIT_TYPE setting unit 132 sets I(12), which is an I picture of a second GOP, in a top field in the reproduction order and sets the NAL unit type to “TRAIL_R” (“CRA_NUT” in the cases of A of FIG. 5 and A of FIG. 10). The NAL_UNIT_TYPE setting unit 132 then sets P(13), which is a P picture that follows I(12), in a bottom field paired with I(12). Note that the NAL unit type of (12) is set to “TRAIL_R,” and therefore, the random access of B(8) to B(11) is lost. The NAL unit type of B(8) to B(11) is set to “TRAIL_N.” In this case, I(12) is a trailing picture, and therefore, the rearrangement unit 133 can arrange P(13) after I(12) of the second GOP in the decoding order as illustrated in B of FIG. 13. That is, the decoding order can also prevent the violation of the standard of the HEVC. Therefore, the same GOP structure as the AVC can also be realized in this case.

### 3. Second Embodiment

### <I Picture of Bottom Field>

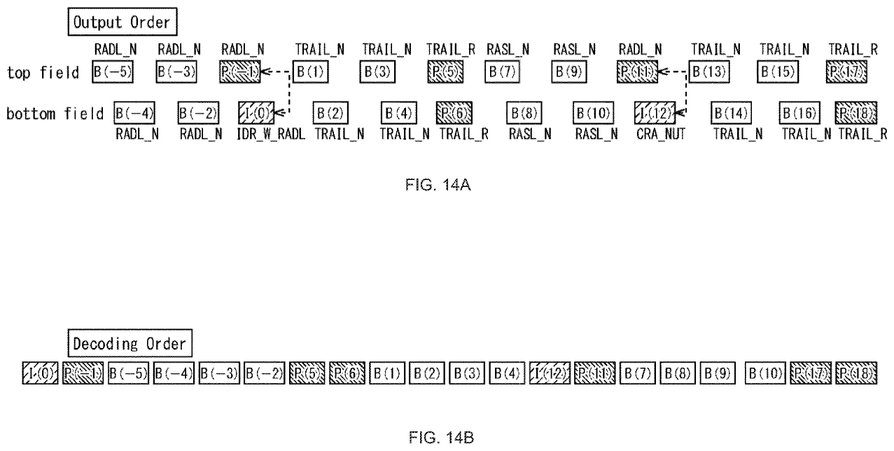

As illustrated in A of FIG. 14, the nal_unit_type of each field may be set in each GOP of the interlaced images input in the reproduction order, and the I picture may be set in a bottom field. The P picture that follows the I picture in the decoding order may be set in a top field paired with the I picture and may be set as a leading picture. Each field provided with the nal_unit_type may be encoded.

The image encoding apparatus 100 described in the first embodiment can realize the method. For example, in the case of A of FIG. 14, the NAL_UNIT_TYPE setting unit 132 sets I(0) and I(12) in bottom fields in the reproduction order and sets P(−1) and P(11) in top fields. The NAL_UNIT_TYPE setting unit 132 then sets the NAL unit type of I(0) to “IDR_W_RADL,” sets the NAL unit type of I(12) to “CRA_NUT,” and sets P(−1) and P(11) as leading pictures “RADL_N.” Therefore, the violation of the standard of the HEVC can also be prevented when the rearrangement unit 133 arranges each field in the decoding order as illustrated in B of FIG. 14. For example, in the case of B of FIG. 14, P(−1) is arranged after I(0), that is, before B(−5) to B(−2). However, P(−1) is a leading picture, and the standard of the HEVC is not violated. Similarly, P(11) is arranged after I(12), that is, before B(7) to B(10). However, P(11) is a leading picture, and the standard of the HEVC is not violated. Therefore, the same GOP structure as the AVC can also be realized in this case.

Note that in this way, B(−5) to B(−2) can refer to not only I(0), but also P(−1) (A of FIG. 14). Similarly, B(7) to B(10) can refer to not only I(12), but also P(11). That is, the B picture can refer to not only the I picture, but also the P picture paired with the I picture. Therefore, the reduction in the prediction accuracy can be reduced, and the reduction in the encoding efficiency can be reduced.

In addition, the decoding order can prevent the violation of the standard of the HEVC without eliminating the encoding and the decoding of the leading pictures. For example, B(−5) to B(−2) and B(7) to B(10) are also encoded and decoded in B of FIG. 14. This can suppress the reduction in the subjective image quality of the decoded images caused by the reduction in the number of fields. Furthermore, the NAL unit type (nal_unit_type) is basically similar to the case of FIG. 5, and the reduction in the random access can also be suppressed. In addition, the NAL unit type does not have to be newly defined, and this can facilitate the realization.

Note that in addition, the image decoding apparatus 200 described in the first embodiment properly understands, properly decodes, and properly rearranges the NAL unit type and the arrangement order of each field set by the image encoding apparatus 100 in this case. Therefore, the same GOP structure as the AVC can be realized in the case of the field coding.

### <I Picture as Trailing Picture>

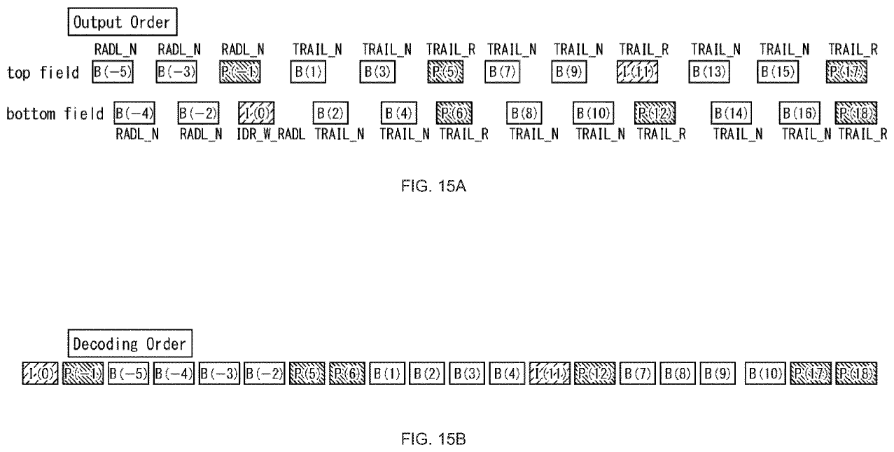

Note that in this case, the I picture may also be set as a trailing picture in a second or subsequent GOP. For example, in a case of A of FIG. 15, the NAL_UNIT_TYPE setting unit 132 sets I(11), which is an I picture of the second GOP, in a top field in the reproduction order and sets the NAL unit type of I(11) to “TRAIL_R” (“CRA_NUT” in the cases of A of FIG. 5 and A of FIG. 10). The NAL_UNIT_TYPE setting unit 132 then sets P(12), which is a P picture that follows I(11), in a bottom field paired with I(11). Note that the NAL unit type of I(11) is set to “TRAIL_R,” and therefore, the random access of B(7) to B(10) is lost. The NAL unit type of B(7) to B(10) is set to “TRAIL_N.” In this case, I(11) is a trailing picture, and the rearrangement unit 133 can arrange P(12) after I(11) of the second GOP in the decoding order as illustrated in B of FIG. 15. That is, the decoding order can also prevent the violation of the standard of the HEVC. Therefore, the same GOP structure as the AVC can also be realized in this case.

### Combination with Other Embodiments

Note that the method described in the present embodiment may be combined with the method described in the first embodiment. For example, the GOP according to the method described in the present embodiment and the GOP according to the method described in the first embodiment may be mixed in the moving images to be encoded.

For example, in the first GOP of the interlaced images input in the reproduction order, the I picture may be set in a bottom field, and the P picture that follows the I picture in the decoding order may be set in a top field paired with the I picture and set as a leading picture as described in the present embodiment. In the second or subsequent GOP, the I picture may be set in a top field, and the P picture that follows the I picture in the decoding order may be set in a bottom field paired with the I picture and set as a trailing picture. Furthermore, the P picture of the bottom field paired with the I picture of the top field in the reproduction order may be rearranged such that the P picture follows the leading pictures as described in the first embodiment.

In addition, for example, in the first GOP of the interlaced images input in the reproduction order, the I picture may be set in a top field, and the P picture that follows the I picture in the decoding order may be set in a bottom field paired with the I picture and set as a trailing picture. Furthermore, the P picture of the bottom field paired with the I picture of the top field in the reproduction order may be rearranged such that the P picture follows the leading pictures as described in the first embodiment. In the second or subsequent GOP, the I picture may be set in a bottom field, and the P picture that follows the I picture in the decoding order may be set in a top field paired with the I picture and set as a leading picture as described in the present embodiment.

In either case, the advantageous effect described in the first embodiment can be obtained for the GOP according to the method described in the first embodiment, and the advantageous effect described in the present embodiment can be obtained for the GOP according to the method described in the present embodiment.

### 4. Third Embodiment

### <Elimination of Leading Pictures>

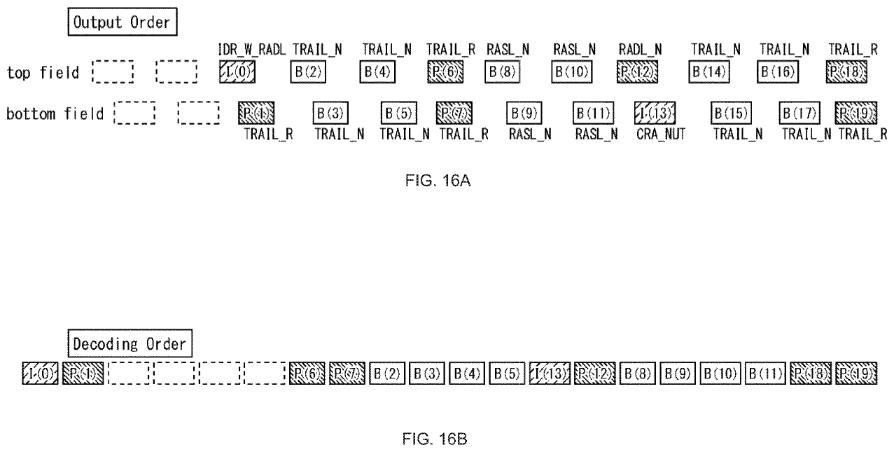

As illustrated in A of FIG. 16, each field in each GOP of the interlaced images input in the reproduction order may be rearranged such that the leading pictures that precede the I picture in the reproduction order are eliminated in the decoding order.

The image encoding apparatus 100 described in the first embodiment can realize the method. For example, in the case of A of FIG. 16, the NAL_UNIT_TYPE setting unit 132 deletes the leading pictures of the first GOP in the reproduction order, that is, four fields from B(−4) to B(−1) (FIG. 5). Therefore, when the rearrangement unit 133 rearranges the pictures in the decoding order as in the case of FIG. 5, B(−4) to B(−1) positioned after P(−1) in the case of B of FIG. 5 are also eliminated in the decoding order as illustrated in B of FIG. 16. That is, there are no leading pictures, and the standard of the HEVC is not violated. Therefore, the same GOP structure as the AVC can also be realized in this case.

Note that in this way, the P picture not paired with the I picture can refer to not only the I picture, but also the P picture paired with the I picture. Therefore, the reduction in the prediction accuracy can be suppressed, and the reduction in the encoding efficiency can be suppressed. For example, in A of FIG. 16, P(6) and P(7) can refer to not only I(0), but also P(1).

Furthermore, the NAL unit type (nal_unit_type) is basically similar to the case of FIG. 5, and the reduction in the random access can also be suppressed. In addition, the NAL unit type does not have to be newly defined, and this can facilitate the realization.

Note that in addition, the image decoding apparatus 200 described in the first embodiment properly understands, properly decodes, and properly rearranges the NAL unit type and the arrangement order of each field set by the image encoding apparatus 100 in this case. Therefore, the same GOP structure as the AVC can be realized in the case of the fielding coding.

### <I Picture as Trailing Picture>

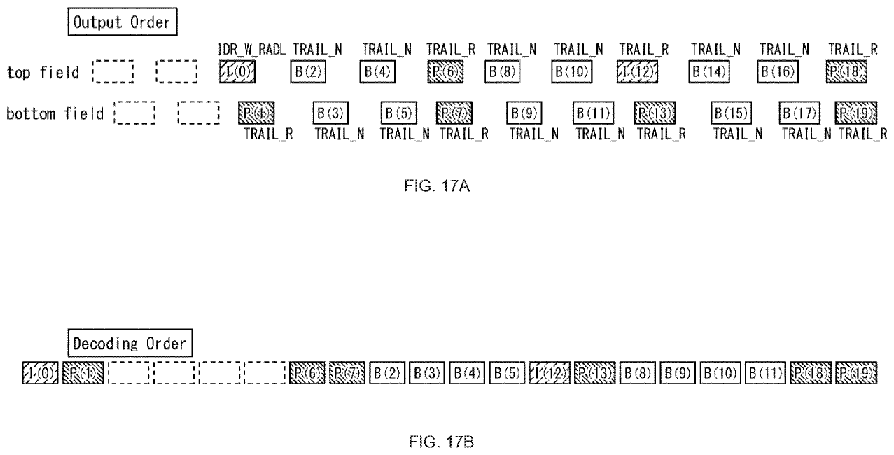

Note that in this case, the I picture may also be set as a trailing picture in the second or subsequent GOP. For example, in a case of A of FIG. 17, the NAL_UNIT_TYPE setting unit 132 sets I(12), which is an I picture of the second GOP, in a top field in the reproduction order and sets the NAL unit type of I(12) to “TRAIL_R” (“CRA_NUT” in the cases of A of FIG. 5 and A of FIG. 10). The NAL_UNIT_TYPE setting unit 132 then sets P(13), which is a P picture that follows I(12), in a bottom field paired with I(12). Note that the NAL unit type of I(12) is set to “TRAIL_R,” and therefore, the random access of B(8) to B(11) is lost. The NAL unit type of B(8) to B(11) is set to “TRAIL_N.” In this case, I(12) is a trailing picture, and therefore, the rearrangement unit 133 can arrange P(13) after I(12) of the second GOP in the decoding order as illustrated in B of FIG. 17. That is, the decoding order can also prevent the violation of the standard of the HEVC. Therefore, the same GOP structure as the AVC can also be realized in this case.

### Combination with Other Embodiments

Note that the method described in the present embodiment may be combined with the methods described in the other embodiments. For example, the method described in the present embodiment may be combined with the method described in the second embodiment. For example, the GOP according to the method described in the present embodiment and the GOP according to the method described in the second embodiment may be mixed in the moving images to be encoded.

For example, as illustrated in FIG. 16, in the first GOP of the interlaced images input in the reproduction order, the decoding order may be rearranged to eliminate the leading pictures as described in the present embodiment. In the second or subsequent GOP, the I picture may be set in a bottom field, and the P picture that follows the I picture in the decoding order may be set in a top field paired with the I picture and set as a leading picture as described in the second embodiment.

In the case of A of FIG. 16, I(13), which is an I picture of the second GOP, is set in a bottom field, and P(12) (B of FIG. 16), which is a P picture that follows the I picture in the decoding order, is set in a top field paired with I(13) and set as a leading picture. In this way, when the rearrangement unit 133 rearranges the pictures in the decoding order as in B of FIG. 16, that is, when the rearrangement unit 133 arranges P(12) such that P(12) precedes B(8) to B(11), the violation of the standard of the HEVC can also be prevented.

Obviously, the method described in the second embodiment may be applied to the first GOP, and the method described in the present embodiment may be applied to the second or subsequent GOP.

In either case, the advantageous effect described in the second embodiment can be obtained for the GOP according to the method described in the second embodiment, and the advantageous effect described in the present embodiment can be obtained for the GOP according to the method described in the present embodiment.

Similarly, the method described in the present embodiment may be combined with the method described in the first embodiment. For example, the GOP according to the method described in the present embodiment and the GOP according to the method described in the first embodiment may be mixed in the moving images to be encoded.

For example, the method described in the present embodiment may be applied to the first GOP, and the method described in the first embodiment may be applied to the second or subsequent GOP. In addition, for example, the method described in the first embodiment may be applied to the first GOP, and the method described in the present embodiment may be applied to the second or subsequent GOP.

In either case, the advantageous effect described in the first embodiment can be obtained for the GOP according to the method described in the first embodiment, and the advantageous effect described in the present embodiment can be obtained for the GOP according to the method described in the present embodiment.

Furthermore, similarly, all of the methods described in the embodiments may be combined. For example, the GOP according to the method described in the present embodiment, the GOP according to the method described in the first embodiment, and the GOP according to the method described in the second embodiment may be mixed in the moving images to be encoded.

### 5. Fourth Embodiment

### <Addition of NAL Unit Type>

In each GOP of the interlaced images input in the reproduction order, nal_unit_type of each field may be set, and nal_unit_type indicative of the picture paired with the I picture may be set for the P picture of the field paired with the I picture. Each field provided with the nal_unit_type may be encoded.

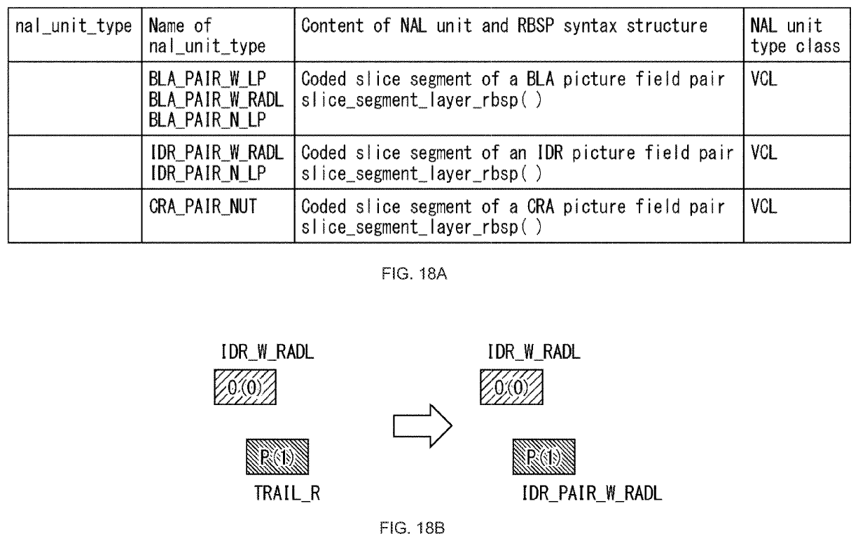

The image encoding apparatus 100 described in the first embodiment can realize the method. For example, the NAL unit type as illustrated in a table of A of FIG. 18 is added to the syntax. In the table of A of FIG. 18, BLA_PAIR_W_LP, BLA_PAIR_W_RADL, and BLA_PAIR_N_LP are NAL unit types indicative of pictures paired with BLA pictures. IDR_PAIR_W_RADL and IDR_PAIR_N_LP are NAL unit types indicative of pictures paired with IDR pictures. CRA_PAIR_NUT is a NAL unit type indicative of a picture paired with a CRA picture. Note that actually, the NAL unit type is indicated by a numerical value (for example, 6 bits). The values indicating the NAL unit types are arbitrary. For example, numerical values vacant in the standard of the HEVC may be allocated.

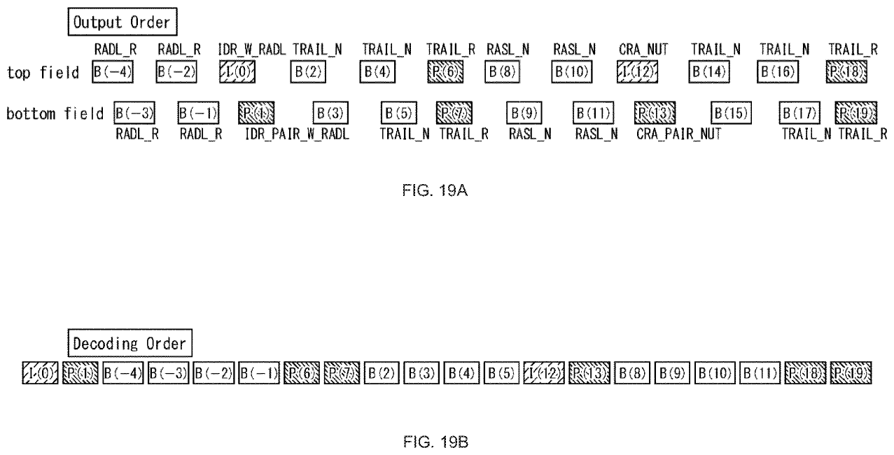

In addition, the NAL_UNIT_TYPE setting unit 132 is only required to set the NAL unit type for the P picture of the field paired with the I picture as illustrated in B of FIG. 18. For example, in a case of A of FIG. 19, the NAL_UNIT_TYPE setting unit 132 sets P(1) in the bottom field paired with I(0) of the NAL unit type “IDR_W_RADL” in the reproduction order and sets the NAL unit type to “IDR_PAIR_W_RADL.” In addition, the NAL_UNIT_TYPE setting unit 132 sets P(13) in the bottom field paired with I(12) of the NAL unit type “CRA_NUT” and sets the NAL unit type to “CRA_PAIR_NUT.”

Therefore, when the rearrangement unit 133 arranges each field in the decoding order as illustrated in B of FIG. 19, the violation of the standard of the HEVC can also be prevented. For example, in a case of B of FIG. 19, P(1) is arranged after I(0), that is, before B(−4) to B(−1). However, the NAL unit type is “IDR_PAIR_W_RADL,” and P(1) is not a trailing picture. Therefore, the standard of the HEVC is not violated. Similarly, P(13) is arranged after I(12), that is, before B(8) to B(11). However, the NAL unit type is “CRA_PAIR_NUT,” and P(13) is not a trailing picture. Therefore, the standard of the HEVC is not violated. As a result, the same GOP structure as the AVC can also be realized in this case.

Note that in this way, B(−4) to B(−1) can refer to not only I(0), but also P(1) in the decoding order (A of FIG. 19). Similarly, B(8) to B(11) can refer to not only I(12), but also P(13). That is, the B picture can refer to not only the I picture, but also the P picture paired with the I picture. Therefore, the reduction in the prediction accuracy can be suppressed, and the reduction in the encoding efficiency can be suppressed.

Furthermore, in this way, the P picture not paired with the I picture can refer to not only the I picture, but also the P picture paired with the I picture. Therefore, the reduction in the prediction accuracy can be suppressed, and the reduction in the encoding efficiency can be suppressed. For example, P(6) and P(7) can refer to not only I(0), but also P(1) in A of FIG. 19. Similarly, P(18) and P(19) can refer to not only I(12), but also P(13).

Furthermore, in this way, the violation of the standard of the HEVC can be prevented without eliminating the encoding and the decoding of the leading pictures. For example, B(−4) to B(−1) and B(8) to B(11) are also encoded and decoded in B of FIG. 19. This can suppress the reduction in the subjective image quality of the decoded images caused by the reduction in the number of fields. Furthermore, the NAL unit type (nal_unit_type) is basically similar to the case of FIG. 5 except for the P picture paired with the I picture, and therefore, the reduction in the random access can also be suppressed.

Note that in addition, the image decoding apparatus 200 described in the first embodiment properly understands, properly decodes, and properly rearranges the NAL unit type and the arrangement order of each field set by the image encoding apparatus 100 in this case. Therefore, the same GOP structure as the AVC can be realized in the case of the field coding.

### 6. Fifth Embodiment

### <Encoding and Decoding System>

Although the example of the HEVC has been described above, the present technique can be applied to arbitrary image encoding and decoding in which the scan system can encode and decode interlaced moving images.

### <Scope of Application of Present Technique>

The systems, the apparatuses, the processing units, and the like according to the present technique can be used in arbitrary fields, such as, for example, traffic, medical care, crime prevention, agriculture, livestock industry, mining industry, cosmetics, factories, home appliances, weather, and nature monitoring.

For example, the present technique can also be applied to a system or a device that transmits an image to be viewed. The present technique can also be applied to, for example, a system or a device used for traffic. Furthermore, the present technique can be applied to, for example, a system or a device used for security. The present technique can also be applied to, for example, a system or a device used for sports. Furthermore, the present technique can be applied to, for example, a system or a device used for agriculture. The present technique can also be applied to, for example, a system or a device used for livestock industry. Furthermore, the present technique can be applied to, for example, a system or a device that monitors the state of the nature, such as volcanos, forests, and oceans. The present technique can also be applied to a weather observation system or a weather observation apparatus that observes, for example, the weather, temperature, humidity, wind velocity, sunshine hours, and the like. Furthermore, the present technique can be applied to, for example, a system or a device that observes ecology of the wild life, such as birds, fish, reptiles, amphibians, mammals, insects, and plants.

### <Application to Multi-View Image Encoding System>

The series of processes can be applied to a multi-view image encoding system that performs encoding of multi-view images including images from a plurality of viewpoints (views). In that case, the present technique can be applied to the encoding for each viewpoint (view).

### <Application to Tiered Image Encoding System>

In addition, the series of processes can be applied to a tiered image encoding (scalable encoding) system that encodes tiered images divided into a plurality of layers (tiers) to provide a scalability function for a predetermined parameter. In that case, the present technique can be applied to the encoding for each tier (layer).

### <Computer>

The series of processes can be executed by hardware or can be executed by software. In the case where the series of processes are executed by software, a program included in the software is installed on a computer. Here, examples of the computer include a computer incorporated into dedicated hardware and a general-purpose personal computer that can execute various functions by installing various programs.

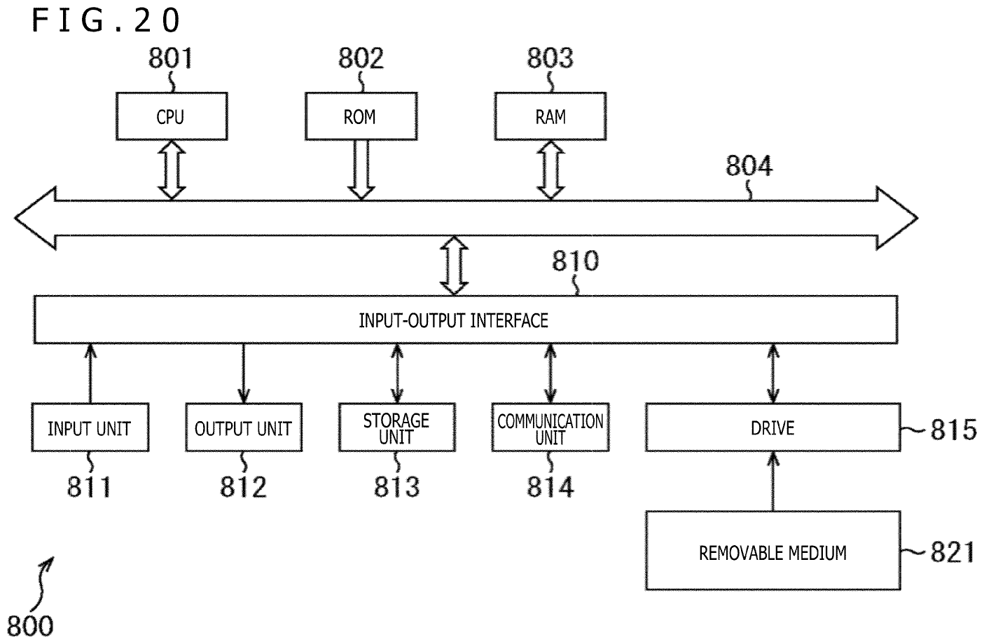

FIG. 20 is a block diagram illustrating a configuration example of the hardware of the computer that uses a program to execute the series of processes.

In a computer 800 illustrated in FIG. 20, a CPU (Central Processing Unit) 801, a ROM (Read Only Memory) 802, and a RAM (Random Access Memory) 803 are connected to each other through a bus 804.

An input-output interface 810 is also connected to the bus 804. An input unit 811, an output unit 812, a storage unit 813, a communication unit 814, and a drive 815 are connected to the input-output interface 810.

The input unit 811 includes, for example, a keyboard, a mouse, a microphone, a touch panel, an input terminal, and the like. The output unit 812 includes, for example, a display, a speaker, an output terminal, and the like. The storage unit 813 includes, for example, a hard disk, a RAM disk, a non-volatile memory, and the like. The communication unit 814 includes, for example, a network interface. The drive 815 drives a removable medium 821, such as a magnetic disk, an optical disk, a magneto-optical disk, and a semiconductor memory.

In the computer configured in this way, the CPU 801 loads, for example, a program stored in the storage unit 813 to the RAM 803 through the input-output interface 810 and the bus 804 to execute the program to thereby execute the series of processes. Data and the like necessary for the CPU 801 to execute various processes are also appropriately stored in the RAM 803.

The program executed by the computer (CPU 801) can be applied by, for example, recording the program in the removable medium 821 as a package medium or the like. In this case, the removable medium 821 can be mounted on the drive 815 to install the program on the storage unit 813 through the input-output interface 810.

The program can also be provided through a wired or wireless transmission medium, such as a local area network, the Internet, and digital satellite broadcasting. In this case, the program can be received by the communication unit 814 and installed on the storage unit 813.

In addition, the program can also be installed in advance on the ROM 802 or the storage unit 813.

### <Application of Present Technique>

The image encoding apparatus 100 according to the embodiments can be applied to, for example, various electronic devices, such as a transmitter and a receiver in satellite broadcasting, cable broadcasting like cable TV, distribution through the Internet, or distribution to a terminal through cellular communication, a recording apparatus that records images in a medium like an optical disk, a magnetic disk, or a flash memory, and a reproduction apparatus that reproduces images from these storage media.

### FIRST APPLICATION EXAMPLE

### Television Receiver

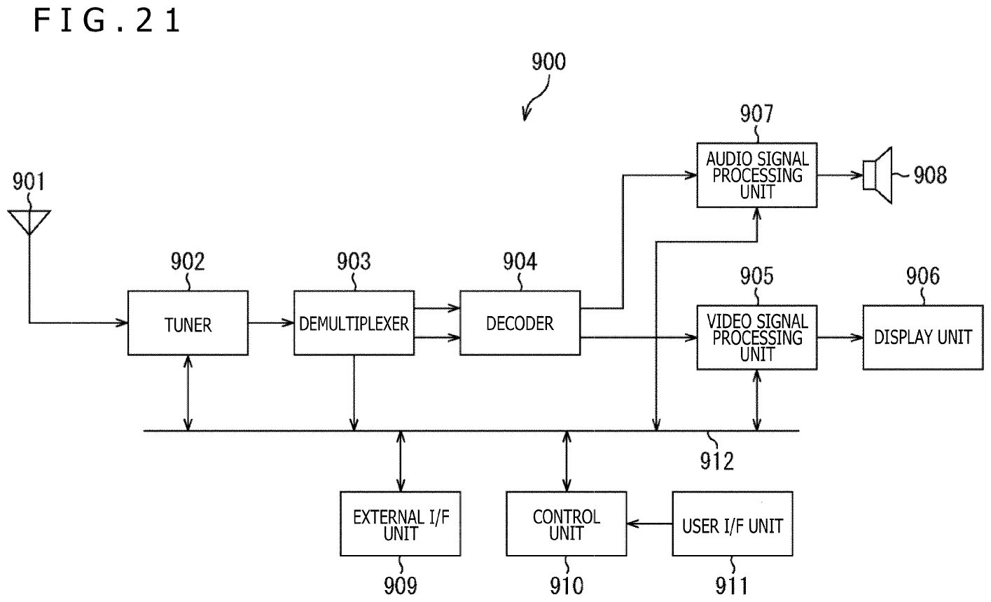

FIG. 21 illustrates an example of a schematic configuration of a television apparatus according to the embodiments. A television apparatus 900 includes an antenna 901, a tuner 902, a demultiplexer 903, a decoder 904, a video signal processing unit 905, a display unit 906, an audio signal processing unit 907, a speaker 908, an external interface (I/F) unit 909, a control unit 910, a user interface (I/F) unit 911, and a bus 912.

The tuner 902 extracts a signal of a desired channel from a broadcast signal received through the antenna 901 and demodulates the extracted signal. The tuner 902 then outputs an encoded bitstream obtained by the demodulation to the demultiplexer 903. That is, the tuner 902 plays a role of a transmission unit in the television apparatus 900 that receives an encoded stream in which an image is encoded.

The demultiplexer 903 separates a video stream and an audio stream of a program to be viewed from the encoded bitstream and outputs each of the separated streams to the decoder 904. The demultiplexer 903 also extracts auxiliary data, such as EPG (Electronic Program Guide), from the encoded bitstream and supplies the extracted data to the control unit 910. Note that in a case where the encoded bitstream is scrambled, the demultiplexer 903 may descramble the encoded bitstream.

The decoder 904 decodes the video stream and the audio stream input from the demultiplexer 903. The decoder 904 then outputs the video data generated in the decoding process to the video signal processing unit 905. The decoder 904 also outputs the audio data generated in the decoding process to the audio signal processing unit 907.

The video signal processing unit 905 reproduces the video data input from the decoder 904 and causes the display unit 906 to display the video. The video signal processing unit 905 may also cause the display unit 906 to display an application screen supplied through a network. The video signal processing unit 905 may also apply, for example, an additional process, such as noise removal, to the video data according to the setting. The video signal processing unit 905 may further generate, for example, an image of GUI (Graphical User Interface), such as a menu, a button, and a cursor, and superimpose the generated image on the output image.

The display unit 906 is driven by a drive signal supplied from the video signal processing unit 905, and the display unit 906 displays a video or an image on a video screen of a display device (for example, liquid crystal display, plasma display, OELD (Organic ElectroLuminescence Display) (organic EL display), or the like).

The audio signal processing unit 907 applies a reproduction process, such as D/A conversion and amplification, to the audio data input from the decoder 904 and causes the speaker 908 to output the sound. The audio signal processing unit 907 may also apply an additional process, such as noise removal, to the audio data.

The external interface unit 909 is an interface for connecting the television apparatus 900 and an external device or a network. For example, the decoder 904 may decode a video stream or an audio stream received through the external interface unit 909. That is, the external interface unit 909 also plays a role of a transmission unit in the television apparatus 900 that receives an encoded stream in which an image is encoded.

The control unit 910 includes a processor, such as a CPU, and a memory, such as a RAM and a ROM. The memory stores a program executed by the CPU, program data, EPG data, data acquired through the network, and the like. The CPU reads and executes the program stored in the memory at, for example, the start of the television apparatus 900. The CPU executes the program to control the operation of the television apparatus 900 according to, for example, an operation signal input from the user interface unit 911.

The user interface unit 911 is connected to the control unit 910. The user interface unit 911 includes, for example, a button and a switch for the user to operate the television apparatus 900, a reception unit of a remote control signal, and the like. The user interface unit 911 detects an operation by the user through these constituent elements to generate an operation signal and outputs the generated operation signal to the control unit 910.

The bus 912 mutually connects the tuner 902, the demultiplexer 903, the decoder 904, the video signal processing unit 905, the audio signal processing unit 907, the external interface unit 909, and the control unit 910.

In the television apparatus 900 configured in this way, the decoder 904 may have the function of the image decoding apparatus 200. That is, the decoder 904 may use the methods described in the embodiments to decode the encoded data. As a result, the television apparatus 900 can obtain advantageous effects similar to the advantageous effects of the embodiments regarding the received encoded bitstream.

In addition, in the television apparatus 900 configured in this way, the video signal processing unit 905 may be able to, for example, encode the image data supplied from the decoder 904 and output the obtained encoded data to the outside of the television apparatus 900 through the external interface unit 909. In addition, the video signal processing unit 905 may have the function of the image encoding apparatus 100. That is, the video signal processing unit 905 may use the methods described in the embodiments to encode the image data supplied from the decoder 904. As a result, the television apparatus 900 can obtain advantageous effects similar to the advantageous effects of the embodiments regarding the output encoded data.

### SECOND APPLICATION EXAMPLE

### Mobile Phone

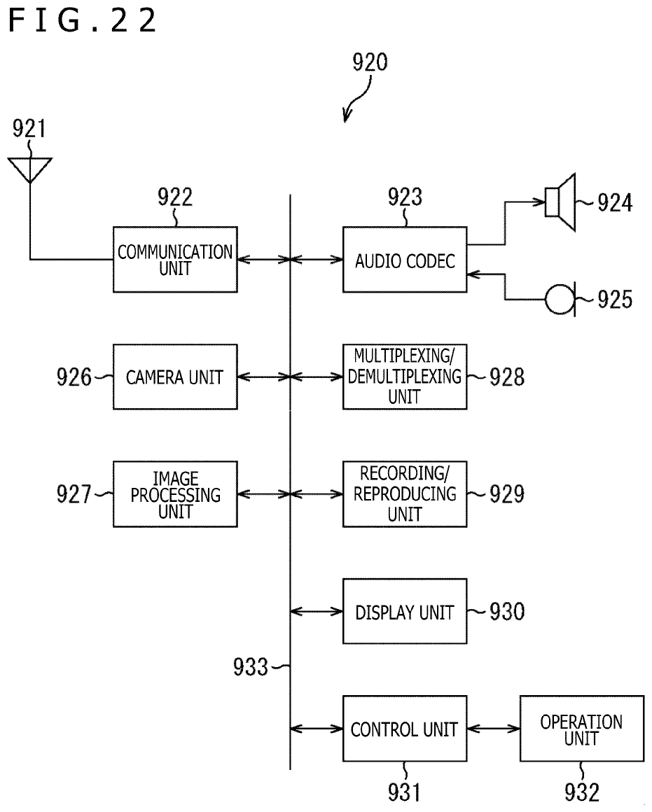

FIG. 22 illustrates an example of a schematic configuration of a mobile phone according to the embodiments. A mobile phone 920 includes an antenna 921, a communication unit 922, an audio codec 923, a speaker 924, a microphone 925, a camera unit 926, an image processing unit 927, a multiplexing/demultiplexing unit 928, a recording/reproducing unit 929, a display unit 930, a control unit 931, an operation unit 932, and a bus 933.

The antenna 921 is connected to the communication unit 922. The speaker 924 and the microphone 925 are connected to the audio codec 923. The operation unit 932 is connected to the control unit 931. The bus 933 mutually connects the communication unit 922, the audio codec 923, the camera unit 926, the image processing unit 927, the multiplexing/demultiplexing unit 928, the recording/reproducing unit 929, the display unit 930, and the control unit 931.

The mobile phone 920 performs operations, such as transmitting and receiving an audio signal, transmitting and receiving email or image data, capturing an image, and recording data, in various operation modes including a voice call mode, a data communication mode, an imaging mode, and a TV phone mode.

In the voice call mode, an analog audio signal generated by the microphone 925 is supplied to the audio codec 923. The audio codec 923 converts the analog audio signal into audio data and performs A/D conversion to compress the converted audio data. The audio codec 923 then outputs the compressed audio data to the communication unit 922. The communication unit 922 encodes and modulates the audio data to generate a transmission signal. The communication unit 922 then transmits the generated transmission signal to a base station (not illustrated) through the antenna 921. The communication unit 922 also amplifies a wireless signal received through the antenna 921 and converts the frequency to acquire a reception signal. The communication unit 922 then demodulates and decodes the reception signal to generate audio data and outputs the generated audio data to the audio codec 923. The audio codec 923 expands and performs D/A conversion of the audio data to generate an analog audio signal. The audio codec 923 then supplies the generated audio signal to the speaker 924 to output the sound.

In addition, for example, the control unit 931 generates character data of an email according to an operation by the user through the operation unit 932 in the data communication mode. The control unit 931 also causes the display unit 930 to display the characters. The control unit 931 also generates email data according to a transmission instruction from the user through the operation unit 932 and outputs the generated email data to the communication unit 922. The communication unit 922 encodes and modulates the email data to generate a transmission signal. The communication unit 922 then transmits the generated transmission signal to a base station (not illustrated) through the antenna 921. The communication unit 922 also amplifies a wireless signal received through the antenna 921 and converts the frequency to acquire a reception signal. The communication unit 922 then demodulates and decodes the reception signal to restore the email data and outputs the restored email data to the control unit 931. The control unit 931 causes the display unit 930 to display the content of the email and supplies the email data to the recording/reproducing unit 929 to write the email data to a storage medium of the recording/reproducing unit 929.

The recording/reproducing unit 929 includes an arbitrary read/write storage medium. For example, the storage medium may be a built-in storage medium, such as a RAM and a flash memory, or may be an externally mounted storage medium, such as a hard disk, a magnetic disk, a magneto-optical disk, an optical disk, a USB (Universal Serial Bus) memory, and a memory card.

In addition, for example, the camera unit 926 images a subject to generate image data and outputs the generated image data to the image processing unit 927 in the imaging mode. The image processing unit 927 encodes the image data input from the camera unit 926 and supplies the encoded stream to the recording/reproducing unit 929 to write the encoded stream to the storage medium of the recording/reproducing unit 929.

Furthermore, the recording/reproducing unit 929 reads an encoded stream recorded in the storage medium and outputs the encoded stream to the image processing unit 927 in the image display mode. The image processing unit 927 decodes the encoded stream input from the recording/reproducing unit 929 and supplies the image data to the display unit 930 to display the image.

In addition, for example, the multiplexing/demultiplexing unit 928 multiplexes a video stream encoded by the image processing unit 927 and an audio stream input from the audio codec 923 and outputs the multiplexed stream to the communication unit 922 in the TV phone mode. The communication unit 922 encodes and modulates the stream to generate a transmission signal. The communication unit 922 then transmits the generated transmission signal to a base station (not illustrated) through the antenna 921. The communication unit 922 also amplifies a wireless signal received through the antenna 921 and converts the frequency to acquire a reception signal. The transmission signal and the reception signal can include encoded bitstreams. The communication unit 922 then demodulates and decodes the reception signal to restore the stream and outputs the restored stream to the multiplexing/demultiplexing unit 928. The multiplexing/demultiplexing unit 928 separates a video stream and an audio stream from the input stream, outputs the video stream to the image processing unit 927, and outputs the audio stream to the audio codec 923. The image processing unit 927 decodes the video stream to generate video data. The video data is supplied to the display unit 930, and the display unit 930 displays a series of images. The audio codec 923 expands and performs D/A conversion of the audio stream to generate an analog audio signal. The audio codec 923 then supplies the generated audio signal to the speaker 924 to output the sound.

In the mobile phone 920 configured in this way, the image processing unit 927 may have, for example, one of or both the function of the image encoding apparatus 100 and the function of the image decoding apparatus 200. That is, the image processing unit 927 may use the methods described in the embodiments to encode and decode the image data. As a result, the mobile phone 920 can obtain advantageous effects similar to the advantageous effects of the embodiments.

### THIRD APPLICATION EXAMPLE

### Recording/Reproducing Apparatus

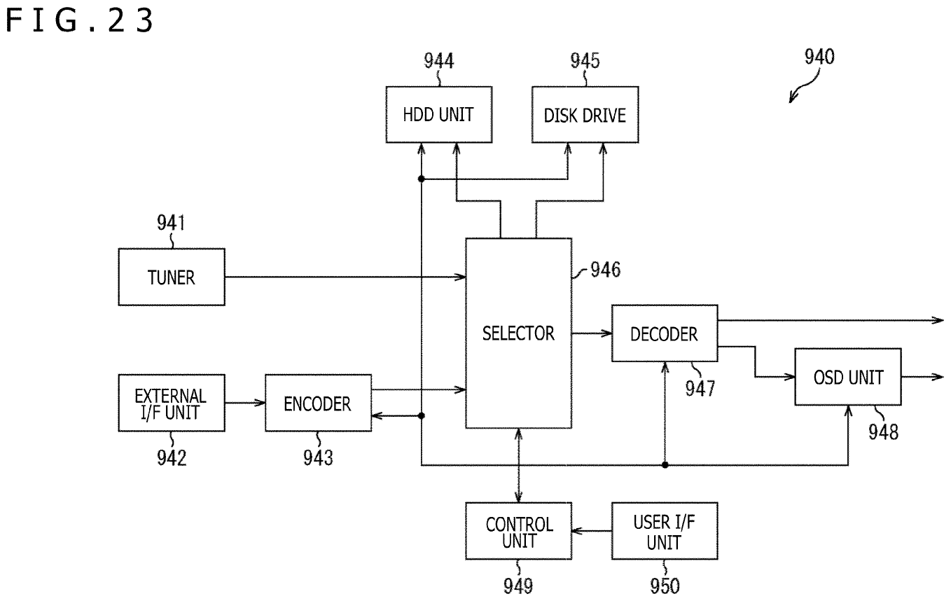

FIG. 23 illustrates an example of a schematic configuration of a recording/reproducing apparatus according to the embodiments. For example, a recording/reproducing apparatus 940 encodes audio data and video data of a received broadcast program and records the audio data and the video data in a recording medium. The recording/reproducing apparatus 940 may also encode audio data and video data acquired from another apparatus and record the audio data and the video data in the recording medium, for example. The recording/reproducing apparatus 940 also reproduces data recorded in the recording medium on a monitor and a speaker according to an instruction of the user, for example. In this case, the recording/reproducing apparatus 940 decodes audio data and video data.

The recording/reproducing apparatus 940 includes a tuner 941, an external interface (I/F) unit 942, an encoder 943, an HDD (Hard Disk Drive) unit 944, a disk drive 945, a selector 946, a decoder 947, an OSD (On-Screen Display) unit 948, a control unit 949, and a user interface (I/F) unit 950.

The tuner 941 extracts a signal of a desired channel from a broadcast signal received through an antenna (not illustrated) and demodulates the extracted signal. The tuner 941 then outputs an encoded bitstream obtained by the demodulation to the selector 946. That is, the tuner 941 plays a role of a transmission unit in the recording/reproducing apparatus 940.

The external interface unit 942 is an interface for connecting the recording/reproducing apparatus 940 and an external device or a network. The external interface unit 942 may be, for example, an IEEE (Institute of Electrical and Electronic Engineers) 1394 interface, a network interface, a USB interface, a flash memory interface, or the like. For example, video data and audio data received through the external interface unit 942 are input to the encoder 943. That is, the external interface unit 942 plays a role of a transmission unit in the recording/reproducing apparatus 940.

The encoder 943 encodes video data and audio data in a case where the video data and the audio data input from the external interface unit 942 are not encoded. The encoder 943 then outputs an encoded bitstream to the selector 946.

The HDD unit 944 records encoded bitstreams including compressed content data of video, sound, and the like, various programs, and other data in an internal hard disk. The HDD unit 944 also reads the data from the hard disk at the reproduction of the video and the sound.

The disk drive 945 records and reads data to and from a mounted recording medium. The recording medium mounted on the disk drive 945 may be, for example, a DVD (Digital Versatile Disc) disk (DVD-Video, DVD-RAM (DVD-Random Access Memory), DVD-R (DVD-Recordable), DVD-RW (DVD-Rewritable), DVD+R (DVD+Recordable), DVD+RW (DVD+Rewritable), or the like), a Blu-ray (registered trademark) disk, or the like.

At the recording of the video and the sound, the selector 946 selects an encoded bitstream input from the tuner 941 or the encoder 943 and outputs the selected encoded bitstream to the HDD unit 944 or the disk drive 945. In addition, at the reproduction of the video and the sound, the selector 946 outputs the encoded bitstream input from the HDD unit 944 or the disk drive 945 to the decoder 947.

The decoder 947 decodes the encoded bitstream to generate video data and audio data. The decoder 947 then outputs the generated video data to the OSD unit 948. In addition, the decoder 947 outputs the generated audio data to an external speaker.

The OSD unit 948 reproduces the video data input from the decoder 947 and displays the video. The OSD unit 948 may also superimpose, for example, an image of GUI, such as a menu, a button, and a cursor, on the displayed video.

The control unit 949 includes a processor, such as a CPU, and a memory, such as a RAM and a ROM. The memory stores a program executed by the CPU, program data, and the like. The CPU reads and executes the program stored in the memory at, for example, the start of the recording/reproducing apparatus 940. The CPU executes the program to control the operation of the recording/reproducing apparatus 940 according to, for example, an operation signal input from the user interface unit 950.

The user interface unit 950 is connected to the control unit 949. The user interface unit 950 includes, for example, a button and a switch for the user to operate the recording/reproducing apparatus 940, a reception unit of a remote control signal, and the like. The user interface unit 950 detects an operation by the user through these constituent elements to generate an operation signal and outputs the generated operation signal to the control unit 949.

In the recording/reproducing apparatus 940 configured in this way, the encoder 943 may have, for example, the function of the image encoding apparatus 100. That is, the encoder 943 may use the methods described in the embodiments to encode the image data. As a result, the recording/reproducing apparatus 940 can obtain advantageous effects similar to the advantageous effects of the embodiments.

Furthermore, in the recording/reproducing apparatus 940 configured in this way, the decoder 947 may have, for example, the function of the image decoding apparatus 200. That is, the decoder 947 may use the methods described in the embodiments to decode the encoded data. As a result, the recording/reproducing apparatus 940 can obtain advantageous effects similar to the advantageous effects of the embodiments.

### FOURTH APPLICATION EXAMPLE

### Imaging Apparatus

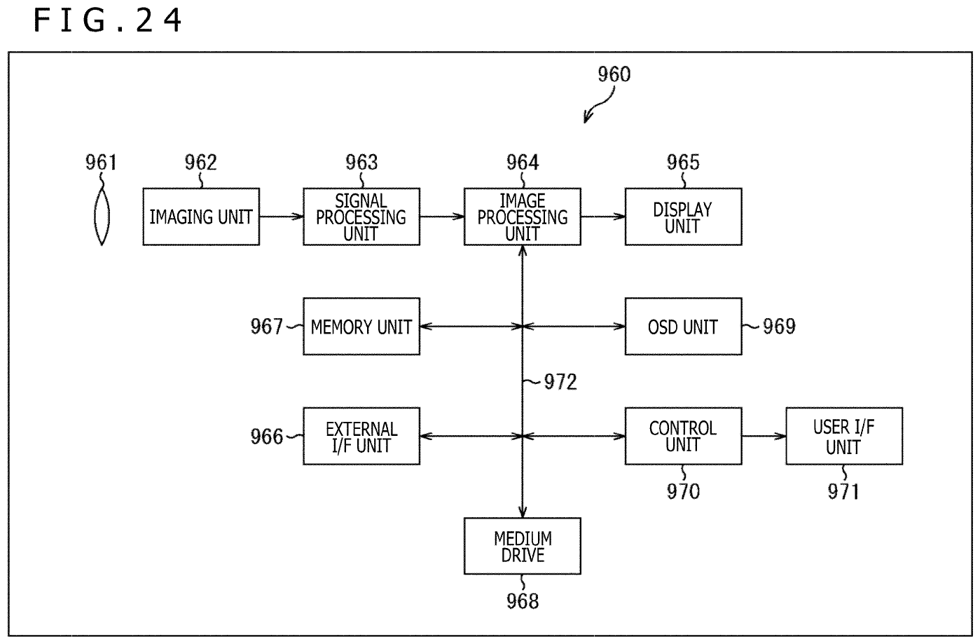

FIG. 24 illustrates an example of a schematic configuration of an imaging apparatus according to the embodiments. An imaging apparatus 960 images a subject, generates an image, encodes image data, and records the image data in a recording medium.

The imaging apparatus 960 includes an optical block 961, an imaging unit 962, a signal processing unit 963, an image processing unit 964, a display unit 965, an external interface (I/F) unit 966, a memory unit 967, a medium drive 968, an OSD unit 969, a control unit 970, a user interface (I/F) unit 971, and a bus 972.

The optical block 961 is connected to the imaging unit 962. The imaging unit 962 is connected to the signal processing unit 963. The display unit 965 is connected to the image processing unit 964. The user interface unit 971 is connected to the control unit 970. The bus 972 mutually connects the image processing unit 964, the external interface unit 966, the memory unit 967, the medium drive 968, the OSD unit 969, and the control unit 970.

The optical block 961 includes a focus lens, a diaphragm mechanism, and the like. The optical block 961 forms an optical image of the subject on an imaging surface of the imaging unit 962. The imaging unit 962 includes an image sensor, such as a CCD (Charge Coupled Device) and a CMOS (Complementary Metal Oxide Semiconductor), and performs photoelectric conversion of the optical image formed on the imaging surface to convert the optical image into an image signal as an electrical signal. The imaging unit 962 then outputs the image signal to the signal processing unit 963.

The signal processing unit 963 applies various types of camera signal processing, such as knee correction, gamma correction, and color correction, to the image signal input from the imaging unit 962. The signal processing unit 963 outputs the image data after the camera signal processing to the image processing unit 964.

The image processing unit 964 encodes the image data input from the signal processing unit 963 to generate encoded data. The image processing unit 964 then outputs the generated encoded data to the external interface unit 966 or the medium drive 968. The image processing unit 964 also decodes encoded data input from the external interface unit 966 or the medium drive 968 to generate image data. The image processing unit 964 then outputs the generated image data to the display unit 965. The image processing unit 964 may also output the image data input from the signal processing unit 963 to the display unit 965 to display the image. The image processing unit 964 may also superimpose display data acquired from the OSD unit 969 on the image to be output to the display unit 965.

The OSD unit 969 generates, for example, an image of GUI, such as a menu, a button, and a cursor, and outputs the generated image to the image processing unit 964.

The external interface unit 966 is provided as, for example, a USB input/output terminal. The external interface unit 966 connects, for example, the imaging apparatus 960 and a printer at the printing of an image. A drive is also connected to the external interface unit 966 as necessary. The drive is provided with, for example, a removable medium, such as a magnetic disk and an optical disk, and a program read from the removable medium can be installed on the imaging apparatus 960. Furthermore, the external interface unit 966 may be provided as a network interface connected to a network, such as a LAN and the Internet. That is, the external interface unit 966 plays a role of a transmission unit in the imaging apparatus 960.

A recording medium mounted on the medium drive 968 may be, for example, an arbitrary read/write removable medium, such as a magnetic disk, a magneto-optical disk, an optical disk, and a semiconductor memory. In addition, the recording medium may be fixed and mounted on the medium drive 968 to provide, for example, a non-portable storage unit, such as a built-in hard disk drive and an SSD (Solid State Drive).

The control unit 970 includes a processor, such as a CPU, and a memory, such as a RAM and a ROM. The memory stores a program executed by the CPU, program data, and the like. The CPU reads and executes the program stored in the memory at, for example, the start of the imaging apparatus 960. The CPU executes the program to control the operation of the imaging apparatus 960 according to, for example, an operation signal input from the user interface unit 971.

The user interface unit 971 is connected to the control unit 970. The user interface unit 971 includes, for example, a button, a switch, and the like for the user to operate the imaging apparatus 960. The user interface unit 971 detects an operation by the user through these constituent elements to generate an operation signal and outputs the generated operation signal to the control unit 970.

In the imaging apparatus 960 configured in this way, the image processing unit 964 may have, for example, one of or both the function of the image encoding apparatus 100 and the function of the image decoding apparatus 200. That is, the image processing unit 964 may use the methods described in the embodiments to encode and decode the image data. As a result, the imaging apparatus 960 can obtain advantageous effects similar to the advantageous effects of the embodiments.

### FIFTH APPLICATION EXAMPLE

### Video Set

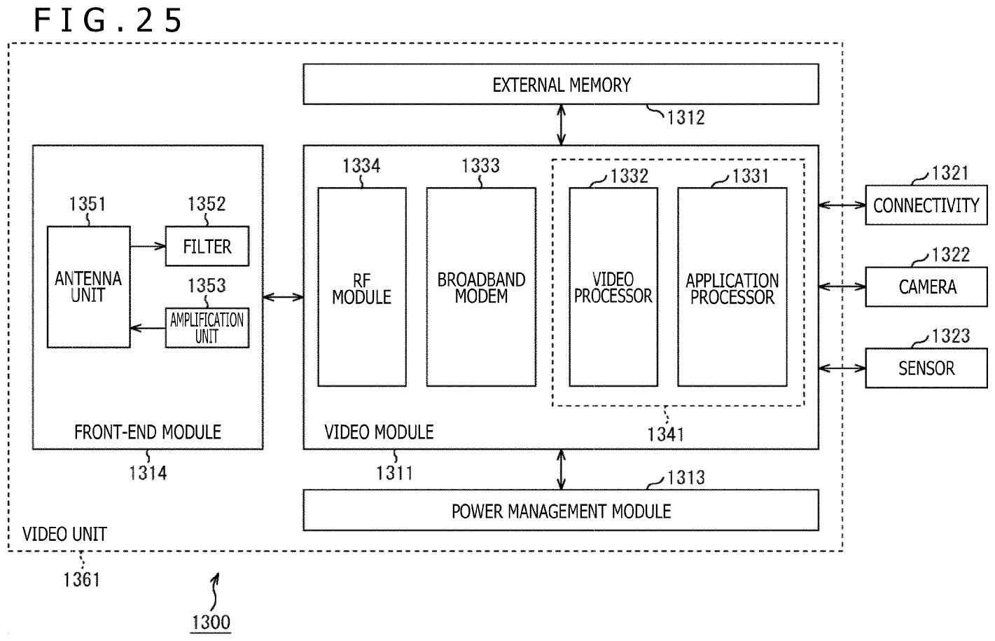

The present technique can also be implemented in any configuration mounted on an apparatus included in an arbitrary apparatus or system, such as, for example, a processor as system LSI (Large Scale Integration) or the like, a module using a plurality of processors or the like, a unit using a plurality of modules or the like, and a set provided with other functions in addition to the unit (that is, configuration of part of an apparatus). FIG. 25 illustrates an example of a schematic configuration of a video set according to the present technique.

In recent years, electronic devices are provided with more functions, and in the development or manufacturing of the electronic devices, there is a case where the configuration of part of the electronic devices is implemented by selling or providing the configuration. Instead of implementing the configuration as a configuration having one function, a plurality of configurations with related functions are often combined to implement the configurations as one set provided with a plurality of functions.

A video set 1300 illustrated in FIG. 25 has such a configuration with multiple functions, and a device having functions regarding encoding or decoding (any one of or both encoding and decoding) of images is combined with a device having other functions related to the functions.

As illustrated in FIG. 25, the video set 1300 includes a module group, such as a video module 1311, an external memory 1312, a power management module 1313, and a front-end module 1314, and a device having related functions, such as a connectivity 1321, a camera 1322, and a sensor 1323.

The modules are components with integrated functions, in which some functions of components related to each other are integrated. The specific physical configuration is arbitrary, and, for example, a plurality of processors with respective functions, electronic circuit elements, such as resistors and capacitors, and other devices can be arranged and integrated on a wiring board or the like. In addition, other modules, processors, and the like can be combined with the modules to provide new modules.

In the case of the example of FIG. 25, components with functions regarding image processing are combined in the video module 1311, and the video module 1311 includes an application processor, a video processor, a broadband modem 1333, and an RF module 1334.

The processor includes components with predetermined functions integrated on a semiconductor chip based on SoC (System On a Chip), and there is also a processor called, for example, system LSI (Large Scale Integration) or the like. The components with predetermined functions may be a logic circuit (hardware configuration), may be a CPU, a ROM, a RAM, and a program executed by using them (software configuration), or may be a combination of them. For example, the processor may include the logic circuit, the CPU, the ROM, the RAM, and the like, and part of the functions may be realized by the logic circuit (hardware configuration). The other functions may be realized by the program executed by the CPU (software configuration).

An application processor 1331 of FIG. 25 is a processor that executes an application regarding image processing. The application executed by the application processor 1331 can not only execute a computing process, but can also control, for example, components inside and outside of the video module 1311, such as a video processor 1332, as necessary in order to realize a predetermined function.

The video processor 1332 is a processor with a function regarding encoding or decoding (one of or both encoding and decoding) of an image.

The broadband modem 1333 performs digital modulation or the like of data (digital signal) to be transmitted in wired or wireless (or both wired and wireless) broadband communication performed through a broadband circuit, such as the Internet and a public phone network, to convert the data into an analog signal and demodulates an analog signal received in the broadband communication to convert the analog signal into data (digital signal). The broadband modem 1333 processes, for example, arbitrary information, such as image data to be processed by the video processor 1332, a stream including encoded image data, an application program, and configuration data.

The RF module 1334 is a module that applies frequency conversion, modulation and demodulation, amplification, a filtering process, and the like to an RF (Radio Frequency) signal transmitted and received through an antenna. For example, the RF module 1334 applies frequency conversion or the like to a baseband signal generated by the broadband modem 1333 to generate an RF signal. In addition, the RF module 1334 applies, for example, frequency conversion or the like to an RF signal received through the front-end module 1314 to generate a baseband signal.

Note that as indicated by a dotted line 1341 in FIG. 25, the application processor 1331 and the video processor 1332 may be integrated to provide one processor.

The external memory 1312 is a module provided outside of the video module 1311 and including a storage device used by the video module 1311. The storage device of the external memory 1312 may be realized by any physical configuration. However, the storage device is generally used to store high-capacity data, such as frame-based image data, in many cases. Therefore, it is desirable to realize the storage device by, for example, a relatively inexpensive high-capacity semiconductor memory, such as a DRAM (Dynamic Random Access Memory).

The power management module 1313 manages and controls power supplied to the video module 1311 (each component in the video module 1311).

The front-end module 1314 is a module that provides a front-end function (circuit at transmitting and receiving end of antenna side) to the RF module 1334. As illustrated in FIG. 25, the front-end module 1314 includes, for example, an antenna unit 1351, a filter 1352, and an amplification unit 1353.

The antenna unit 1351 includes an antenna that transmits and receives wireless signals and also includes components around the antenna. The antenna unit 1351 transmits a wireless signal of a signal supplied from the amplification unit 1353 and supplies the received wireless signal as an electrical signal (RF signal) to the filter 1352. The filter 1352 applies a filtering process or the like to the RF signal received through the antenna unit 1351 and supplies the RF signal after the process to the RF module 1334. The amplification unit 1353 amplifies the RF signal supplied from the RF module 1334 and supplies the RF signal to the antenna unit 1351.

The connectivity 1321 is a module with a function regarding connection to the outside. The physical configuration of the connectivity 1321 is arbitrary. For example, the connectivity 1321 includes a component with a communication function of a standard other than the communication standard corresponding to the broadband modem 1333 and also includes an external input-output terminal and the like.

For example, the connectivity 1321 may include: a module with a communication function in compliance with a wireless communication standard, such as Bluetooth (registered trademark), IEEE 802.11 (for example, Wi-Fi (Wireless Fidelity, registered trademark)), NFC (Near Field Communication), and IrDA (InfraRed Data Association); an antenna that transmits and receives a signal in compliance with the standard; and the like. The connectivity 1321 may also include, for example, a module with a communication function in compliance with a wired communication standard, such as USB (Universal Serial Bus) and HDMI (registered trademark) (High-Definition Multimedia Interface), and a terminal in compliance with the standard. The connectivity 1321 may further include, for example, other data (signal) transmission functions and the like, such as an analog input-output terminal.

Note that the connectivity 1321 may include a device of a transmission destination of data (signal). For example, the connectivity 1321 may include a drive (including not only a drive of a removable medium, but also a hard disk, an SSD (Solid State Drive), a NAS (Network Attached Storage), and the like) that reads and writes data to a recording medium, such as a magnetic disk, an optical disk, a magneto-optical disk, and a semiconductor memory. The connectivity 1321 may also include an output device (such as a monitor and a speaker) of images and sound.

The camera 1322 is a module with a function of imaging a subject to obtain image data of the subject. The image data obtained by the imaging of the camera 1322 is supplied to and encoded by, for example, the video processor 1332.

The sensor 1323 is, for example, a module with arbitrary sensor functions, such as an audio sensor, an ultrasonic sensor, an optical sensor, an illumination sensor, an infrared sensor, an image sensor, a rotation sensor, an angle sensor, an angular velocity sensor, a speed sensor, an acceleration sensor, a tilt sensor, a magnetic identification sensor, an impact sensor, and a temperature sensor. Data detected by the sensor 1323 is supplied to, for example, the application processor 1331 and used by an application or the like.

The configurations of the modules described above may be realized by processors, and conversely, the configurations of the processors described above may be realized by modules.

In the video set 1300 configured as described above, the present technique can be applied to the video processor 1332 as described later. Therefore, the video set 1300 can be implemented as a set according to the present technique.

### <Configuration Example of Video Processor>

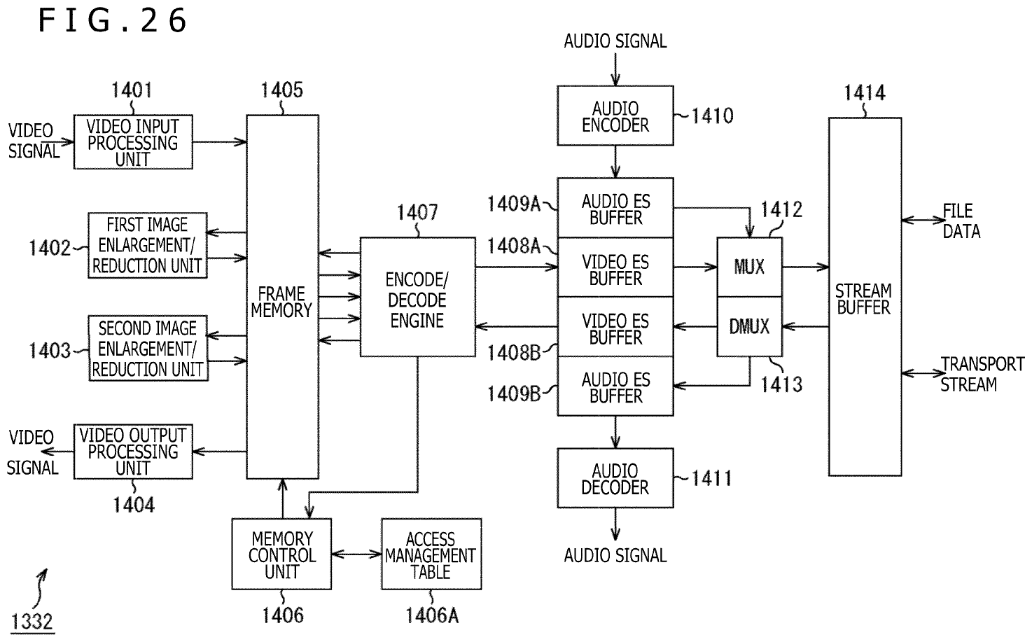

FIG. 26 illustrates an example of a schematic configuration of the video processor 1332 (FIG. 25) according to the present technique.

In the case of the example of FIG. 26, the video processor 1332 has a function of receiving an input of a video signal and an audio signal and using a predetermined system to encode the signals and has a function of decoding encoded video data and audio data and reproducing and outputting a video signal and an audio signal.

As illustrated in FIG. 26, the video processor 1332 includes a video input processing unit 1401, a first image enlargement/reduction unit 1402, a second image enlargement/reduction unit 1403, a video output processing unit 1404, a frame memory 1405, and a memory control unit 1406. The video processor 1332 also includes an encode/decode engine 1407, video ES (Elementary Stream) buffers 1408A and 1408B, and audio ES buffers 1409A and 1409B. The video processor 1332 further includes an audio encoder 1410, an audio decoder 1411, a multiplexing unit (MUX (Multiplexer)) 1412, a demultiplexing unit (DMUX (Demultiplexer)) 1413, and a stream buffer 1414.

The video input processing unit 1401 acquires, for example, a video signal input from the connectivity 1321 (FIG. 25) or the like and converts the video signal into digital image data. The first image enlargement/reduction unit 1402 applies format conversion, enlargement/reduction processing of image, or the like to the image data. The second image enlargement/reduction unit 1403 applies enlargement/reduction processing of image to the image data according to the format at the destination of the output through the video output processing unit 1404 and applies format conversion, enlargement/reduction processing of image, or the like to the image data as in the first image enlargement/reduction unit 1402. The video output processing unit 1404 performs operations, such as converting the format of the image data and converting the image data into an analog signal, and outputs a reproduced video signal to, for example, the connectivity 1321 or the like.

The frame memory 1405 is a memory for image data shared by the video input processing unit 1401, the first image enlargement/reduction unit 1402, the second image enlargement/reduction unit 1403, the video output processing unit 1404, and the encode/decode engine 1407. The frame memory 1405 is realized as, for example, a semiconductor memory, such as a DRAM.

The memory control unit 1406 receives a synchronization signal from the encode/decode engine 1407 to control the access for writing and reading to and from the frame memory 1405 according to a schedule for accessing the frame memory 1405 written in the access management table 1406A. The access management table 1406A is updated by the memory control unit 1406 according to the process executed by the encode/decode engine 1407, the first image enlargement/reduction unit 1402, the second image enlargement/reduction unit 1403, or the like.

The encode/decode engine 1407 executes an encoding process of image data and a decoding process of a video stream in which image data is encoded data. For example, the encode/decode engine 1407 encodes image data read from the frame memory 1405 and sequentially writes video streams to the video ES buffer 1408A. In addition, for example, the encode/decode engine 1407 sequentially reads video streams from the video ES buffer 1408B to decode the video streams and sequentially writes image data to the frame memory 1405. The encode/decode engine 1407 uses the frame memory 1405 as a working area in the encoding and the decoding. The encode/decode engine 1407 also outputs a synchronization signal to the memory control unit 1406 at a timing of, for example, the start of the process for each macroblock.

The video ES buffer 1408A buffers a video stream generated by the encode/decode engine 1407 and supplies the video stream to the multiplexing unit (MUX) 1412. The video ES buffer 1408B buffers a video stream supplied from the demultiplexing unit (DMUX) 1413 and supplies the video stream to the encode/decode engine 1407.

The audio ES buffer 1409A buffers an audio stream generated by the audio encoder 1410 and supplies the audio stream to the multiplexing unit (MUX) 1412. The audio ES buffer 1409B buffers an audio stream supplied from the demultiplexing unit (DMUX) 1413 and supplies the audio stream to the audio decoder 1411.

The audio encoder 1410 performs, for example, digital conversion of an audio signal input from, for example, the connectivity 1321 or the like and uses, for example, a predetermined system, such as an MPEG audio system and an AC3 (AudioCode number 3) system, to encode the audio signal. The audio encoder 1410 sequentially writes, to the audio ES buffer 1409A, audio streams that are data in which the audio signal is encoded. The audio decoder 1411 decodes the audio stream supplied from the audio ES buffer 1409B, performs an operation, such as, for example, converting the audio stream into an analog signal, and supplies a reproduced audio signal to, for example, the connectivity 1321 or the like.

The multiplexing unit (MUX) 1412 multiplexes a video stream and an audio stream. The method of multiplexing (that is, the format of the bitstream generated by multiplexing) is arbitrary. In the multiplexing, the multiplexing unit (MUX) 1412 can also add predetermined header information or the like to the bitstream. That is, the multiplexing unit (MUX) 1412 can convert the format of the stream by multiplexing. For example, the multiplexing unit (MUX) 1412 multiplexes the video stream and the audio stream to convert the streams into a transport stream that is a bitstream in a format for transfer. In addition, for example, the multiplexing unit (MUX) 1412 multiplexes the video stream and the audio stream to convert the streams into data (file data) in a file format for recording.

The demultiplexing unit (DMUX) 1413 uses a method corresponding to the multiplexing by the multiplexing unit (MUX) 1412 to demultiplex a bitstream in which a video stream and an audio stream are multiplexed. That is, the demultiplexing unit (DMUX) 1413 extracts the video stream and the audio stream (separates the video stream and the audio stream) from the bitstream read from the stream buffer 1414. That is, the demultiplexing unit (DMUX) 1413 can demultiplex the stream to convert the format of the stream (inverse transformation of the conversion by the multiplexing unit (MUX) 1412). For example, the demultiplexing unit (DMUX) 1413 can acquire a transport stream supplied from, for example, the connectivity 1321, the broadband modem 1333, or the like through the stream buffer 1414 and demultiplex the transport stream to convert the transport stream into a video stream and an audio stream. In addition, for example, the demultiplexing unit (DMUX) 1413 can acquire file data read by the connectivity 1321 from various recording media through the stream buffer 1414 and demultiplex the file data to convert the file data into a video stream and an audio stream.

The stream buffer 1414 buffers a bitstream. For example, the stream buffer 1414 buffers a transport stream supplied from the multiplexing unit (MUX) 1412 and supplies the transport stream to, for example, the connectivity 1321, the broadband modem 1333, or the like at predetermined timing or based on a request or the like from the outside.

In addition, for example, the stream buffer 1414 buffers file data supplied from the multiplexing unit (MUX) 1412 and supplies the file data to, for example, the connectivity 1321 or the like at predetermined timing or based on a request or the like from the outside to record the file data in various recording media.

The stream buffer 1414 further buffers a transport stream acquired through, for example, the connectivity 1321, the broadband modem 1333, or the like and supplies the transport stream to the demultiplexing unit (DMUX) 1413 at predetermined timing or based on a request or the like from the outside.

The stream buffer 1414 also buffers file data read from various recording media by, for example, the connectivity 1321 or the like and supplies the file data to the demultiplexing unit (DMUX) 1413 at predetermined timing or based on a request or the like from the outside.

Next, an example of an operation of the video processor 1332 configured in this way will be described. For example, the video input processing unit 1401 converts the video signal input from the connectivity 1321 or the like to the video processor 1332 into digital image data of a predetermined system, such as a 4:2:2 Y/Cb/Cr system, and sequentially writes the digital image data to the frame memory 1405. The first image enlargement/reduction unit 1402 or the second image enlargement/reduction unit 1403 reads the digital image data to convert the format into a predetermined system, such as a 4:2:0 Y/Cb/Cr system, and execute enlargement/reduction processing. The digital image data is written again to the frame memory 1405. The encode/decode engine 1407 encodes the image data, and the video stream is written to the video ES buffer 1408A.

In addition, the audio encoder 1410 encodes the audio signal input from the connectivity 1321 or the like to the video processor 1332, and the audio stream is written to the audio ES buffer 1409A.

The video stream of the video ES buffer 1408A and the audio stream of the audio ES buffer 1409A are read and multiplexed by the multiplexing unit (MUX) 1412 and converted into a transport stream, file data, or the like. The transport stream generated by the multiplexing unit (MUX) 1412 is buffered by the stream buffer 1414 and then output to an external network through, for example, the connectivity 1321, the broadband modem 1333, or the like. In addition, the stream buffer 1414 buffers the file data generated by the multiplexing unit (MUX) 1412, and the file data is then output to, for example, the connectivity 1321 or the like and recorded in various recording media.

In addition, for example, the transport stream input from the external network to the video processor 1332 through the connectivity 1321, the broadband modem 1333, or the like is buffered by the stream buffer 1414 and then demultiplexed by the demultiplexing unit (DMUX) 1413. In addition, for example, the file data read from various recording media by the connectivity 1321 or the like and input to the video processor 1332 is buffered by the stream buffer 1414 and then demultiplexed by the demultiplexing unit (DMUX) 1413. That is, the transport stream or the file data input to the video processor 1332 is separated into the video stream and the audio stream by the demultiplexing unit (DMUX) 1413.

The audio stream is supplied to the audio decoder 1411 through the audio ES buffer 1409B and decoded to reproduce the audio signal. In addition, the video stream is written to the video ES buffer 1408B, and then the video stream is sequentially read and decoded by the encode/decode engine 1407 and written to the frame memory 1405. The decoded image data is enlarged or reduced by the second image enlargement/reduction unit 1403 and written to the frame memory 1405. The decoded image data is then read by the video output processing unit 1404, and the format is converted into a predetermined system, such as a 4:2:2 Y/Cb/Cr system. The decoded image data is further converted into an analog signal, and the video signal is reproduced and output.

In the case of applying the present technique to the video processor 1332 configured in this way, the present technique according to each of the embodiments can be applied to the encode/decode engine 1407. That is, for example, the encode/decode engine 1407 may have one of or both the function of the image encoding apparatus 100 and the function of the image decoding apparatus 200. As a result, the video processor 1332 can obtain advantageous effects similar to the advantageous effects of each of the embodiments described above.

Note that in the encode/decode engine 1407, the present technique (that is, the function of the image encoding apparatus 100) may be realized by hardware, such as a logic circuit, may be realized by software, such as an embedded program, or may be realized by both the hardware and the software.

### <Another Configuration Example of Video Processor>

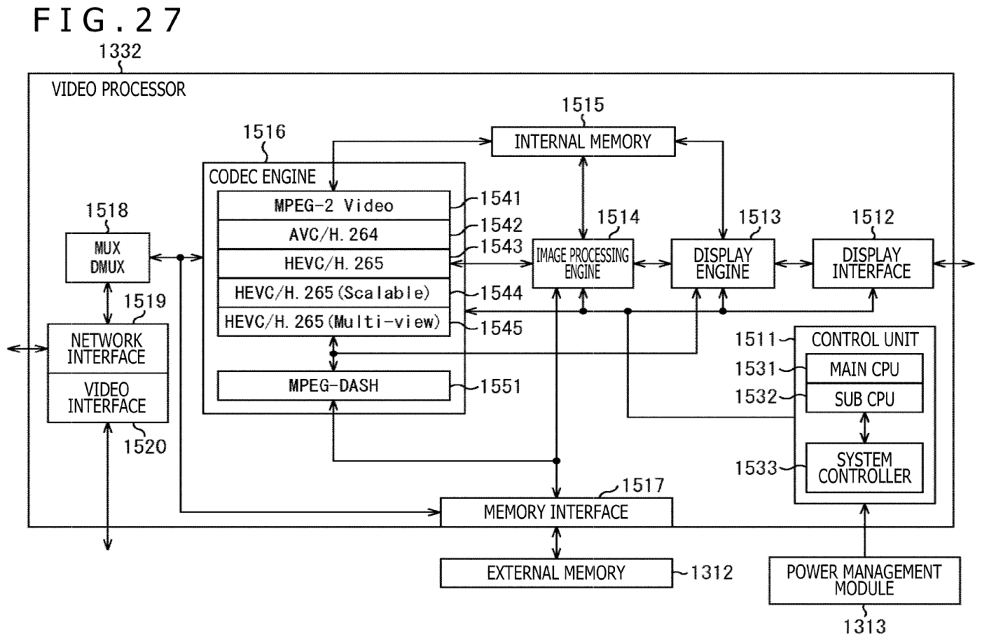

FIG. 27 illustrates another example of the schematic configuration of the video processor 1332 according to the present technique. In the case of the example of FIG. 27, the video processor 1332 has a function of using a predetermined system to encode and decode the video data.

More specifically, as illustrated in FIG. 27, the video processor 1332 includes a control unit 1511, a display interface 1512, a display engine 1513, an image processing engine 1514, and an internal memory 1515. The video processor 1332 also includes a codec engine 1516, a memory interface 1517, a multiplexing/demultiplexing unit (MUX DMUX) 1518, a network interface 1519, and a video interface 1520.

The control unit 1511 controls the operation of each processing unit in the video processor 1332, such as the display interface 1512, the display engine 1513, the image processing engine 1514, and the codec engine 1516.

As illustrated in FIG. 27, the control unit 1511 includes, for example, a main CPU 1531, a sub CPU 1532, and a system controller 1533. The main CPU 1531 executes a program or the like for controlling the operation of each processing unit in the video processor 1332. The main CPU 1531 generates a control signal according to the program or the like and supplies the control signal to each processing unit (that is, controls the operation of each processing unit). The sub CPU 1532 plays an auxiliary role of the main CPU 1531. For example, the sub CPU 1532 executes a child process, a subroutine, or the like of the program or the like executed by the main CPU 1531. The system controller 1533 controls the operations of the main CPU 1531 and the sub CPU 1532, such as designating the program executed by the main CPU 1531 and the sub CPU 1532.

The display interface 1512 outputs image data to, for example, the connectivity 1321 or the like under the control of the control unit 1511. For example, the display interface 1512 converts image data of digital data into an analog signal and outputs a reproduced video signal, or outputs the image data of the digital signal, to a monitor apparatus or the like of the connectivity 1321.

Under the control of the control unit 1511, the display engine 1513 applies various conversion processes, such as format conversion, size conversion, and color gamut conversion, to the image data according to hardware specifications of a monitor apparatus or the like that displays the image.

The image processing engine 1514 applies predetermined image processing, such as, for example, a filtering process for improving the image quality, to the image data under the control of the control unit 1511.

The internal memory 1515 is a memory shared by the display engine 1513, the image processing engine 1514, and the codec engine 1516 and provided inside of the video processor 1332. The internal memory 1515 is used to transfer data between, for example, the display engine 1513, the image processing engine 1514, and the codec engine 1516. For example, the internal memory 1515 stores data supplied from the display engine 1513, the image processing engine 1514, or the codec engine 1516 and supplies the data to the display engine 1513, the image processing engine 1514, or the codec engine 1516 as necessary (for example, according to a request). Although the internal memory 1515 may be realized by any storage device, the internal memory 1515 is generally used to store low-capacity data, such as block-based image data and parameters, in many cases, and it is desirable to realize the internal memory 1515 by a relatively (for example, compared to the external memory 1312) low-capacity semiconductor memory with high response speed, such as an SRAM (Static Random Access Memory).

The codec engine 1516 executes a process regarding encoding and decoding of image data. The system of encoding and decoding corresponding to the codec engine 1516 is arbitrary, and there may be one system or a plurality of systems. For example, the codec engine 1516 may have codec functions of a plurality of encoding and decoding systems and may use selected one of the codec functions to encode image data or decode encoded data.

In the example illustrated in FIG. 27, the codec engine 1516 includes, for example, an MPEG-2 Video 1541, an AVC/H.264 1542, an HEVC/H.265 1543, an HEVC/H.265 (Scalable) 1544, an HEVC/H.265 (Multi-view) 1545, and an MPEG-DASH 1551 that are functional blocks of processes regarding the codec.

The MPEG-2 Video 1541 is a functional block that uses the MPEG-2 system to encode and decode image data. The AVC/H.264 1542 is a functional block that uses the AVC system to encode and decode image data. The HEVC/H.265 1543 is a functional block that uses the HEVC system to encode and decode image data. The HEVC/H.265 (Scalable) 1544 is a functional block that uses the HEVC system to apply scalable encoding and scalable decoding to image data. The HEVC/H.265 (Multi-view) 1545 is a functional block that uses the HEVC system to apply multi-view encoding and multi-view decoding to the image data.

The MPEG-DASH 1551 is a functional block that uses the MPEG-DASH (MPEG-Dynamic Adaptive Streaming over HTTP) system to transmit and receive image data. The MPEG-DASH is a technique of using the HTTP (HyperText Transfer Protocol) to stream a video, and one of the features is that appropriate encoded data is transmitted by selecting the encoded data on a segment-by-segment basis from a plurality of pieces of encoded data with different resolutions or the like prepared in advance. The MPEG-DASH 1551 performs operations, such as generating a stream in compliance with the standard and controlling the transmission of the stream, and uses the components from the MPEG-2 Video 1541 to the HEVC/H.265 (Multi-view) 1545 to encode and decode image data.

The memory interface 1517 is an interface for the external memory 1312. The data supplied from the image processing engine 1514 or the codec engine 1516 is supplied to the external memory 1312 through the memory interface 1517. In addition, the data read from the external memory 1312 is supplied to the video processor 1332 (image processing engine 1514 or codec engine 1516) through the memory interface 1517.

The multiplexing/demultiplexing unit (MUX DMUX) 1518 multiplexes and demultiplexes various types of data regarding the image, such as a bitstream of encoded data, image data, and a video signal. The method of multiplexing and demultiplexing is arbitrary. For example, the multiplexing/demultiplexing unit (MUX DMUX) 1518 can not only group together a plurality of pieces of data in multiplexing, but can also add predetermined header information or the like to the data. In addition, the multiplexing/demultiplexing unit (MUX DMUX) 1518 can not only partition one piece of data into a plurality of pieces of data in demultiplexing, but can also add predetermined header information or the like to each of the partitioned pieces of data. That is, the multiplexing/demultiplexing unit (MUX DMUX) 1518 can multiplex and demultiplex data to convert the format of the data. For example, the multiplexing/demultiplexing unit (MUX DMUX) 1518 can multiplex a bitstream to convert the bitstream into a transport stream that is a bitstream in the format of transfer or into data (file data) in the file format for recording. Obviously, the inverse transformation of the data can also be performed by demultiplexing.

The network interface 1519 is, for example, an interface for the broadband modem 1333, the connectivity 1321, and the like. The video interface 1520 is, for example, an interface for the connectivity 1321, the camera 1322, and the like.

Next, an example of the operation of the video processor 1332 will be described. For example, when a transport stream is received from an external network through the connectivity 1321, the broadband modem 1333, or the like, the transport stream is supplied to the multiplexing/demultiplexing unit (MUX DMUX) 1518 through the network interface 1519 and demultiplexed, and the codec engine 1516 decodes the transport stream. The image processing engine 1514 applies, for example, predetermined image processing to the image data obtained by the decoding of the codec engine 1516, and the display engine 1513 performs predetermined conversion. The image data is supplied to, for example, the connectivity 1321 or the like through the display interface 1512, and the image is displayed on the monitor. In addition, for example, the codec engine 1516 encodes again the image data obtained by the decoding of the codec engine 1516, and the multiplexing/demultiplexing unit (MUX DMUX) 1518 multiplexes the image data and converts the image data into file data. The file data is output to, for example, the connectivity 1321 or the like through the video interface 1520 and recorded in various recording media.

Furthermore, for example, the file data of the encoded data including the encoded image data read by the connectivity 1321 or the like from a recording medium not illustrated is supplied to the multiplexing/demultiplexing unit (MUX DMUX) 1518 through the video interface 1520 and demultiplexed, and the file data is decoded by the codec engine 1516. The image processing engine 1514 applies predetermined image processing to the image data obtained by the decoding of the codec engine 1516, and the display engine 1513 performs predetermined conversion of the image data. The image data is supplied to, for example, the connectivity 1321 or the like through the display interface 1512, and the image is displayed on the monitor. In addition, for example, the codec engine 1516 encodes again the image data obtained by the decoding of the codec engine 1516, and the multiplexing/demultiplexing unit (MUX DMUX) 1518 multiplexes the image data and converts the image data into a transport stream. The transport stream is supplied to, for example, the connectivity 1321, the broadband modem 1333, or the like through the network interface 1519 and transmitted to another apparatus not illustrated.

Note that the transfer of the image data and other data between processing units in the video processor 1332 is performed by using, for example, the internal memory 1515 or the external memory 1312. In addition, the power management module 1313 controls power supplied to, for example, the control unit 1511.

In the case where the present technique is applied to the video processor 1332 configured in this way, the present technique according to each of the embodiments can be applied to the codec engine 1516. That is, for example, the codec engine 1516 is only required to have the function of the image encoding apparatus 100. As a result, the video processor 1332 can obtain advantageous effects similar to the advantageous effects of each of the embodiments.

Note that in the codec engine 1516, the present technique (that is, the function of the image encoding apparatus 100) may be realized by hardware, such as a logic circuit, may be realized by software, such as an embedded program, or may be realized by both the hardware and the software.

Although two configurations of the video processor 1332 have been illustrated, the configuration of the video processor 1332 is arbitrary, and the configuration may be other than the configurations of the two examples. In addition, the video processor 1332 may be provided as one semiconductor chip or may be provided as a plurality of semiconductor chips. For example, the video processor 1332 may be a three-dimensional stacked LSI including a plurality of stacked semiconductors. The video processor 1332 may also be realized by a plurality of LSIs.

### <Examples of Application to Apparatus>

The video set 1300 can be incorporated into various apparatuses that process image data. For example, the video set 1300 can be incorporated into the television apparatus 900 (FIG. 21), the mobile phone 920 (FIG. 22), the recording/reproducing apparatus 940 (FIG. 23), the imaging apparatus 960 (FIG. 24), and the like. The incorporation of the video set 1300 allows the apparatus to obtain advantageous effects similar to the advantageous effects of the embodiments.

Note that part of each configuration of the video set 1300 can be implemented as a configuration according to the present technique as long as the part includes the video processor 1332. For example, the video processor 1332 alone can be implemented as a video processor according to the present technique. In addition, for example, the processor indicated by the dotted line 1341, the video module 1311, or the like can be implemented as a processor, a module, or the like according to the present technique as described above. Furthermore, for example, the video module 1311, the external memory 1312, the power management module 1313, and the front-end module 1314 can be combined to implement a video unit 1361 according to the present technique. In any of the configurations, advantageous effects similar to the advantageous effects of the embodiments can be obtained.

That is, any configuration including the video processor 1332 can be incorporated into various apparatuses that process image data as in the case of the video set 1300. For example, the video processor 1332, the processor indicated by the dotted line 1341, the video module 1311, or the video unit 1361 can be incorporated into the television apparatus 900 (FIG. 21), the mobile phone 920 (FIG. 22), the recording/reproducing apparatus 940 (FIG. 23), the imaging apparatus 960 (FIG. 24), or the like. In addition, the incorporation of one of the configurations according to the present technique allows the apparatus to obtain advantageous effects similar to the advantageous effects of each of the embodiments as in the case of the video set 1300.

### SIXTH APPLICATION EXAMPLE

### Network System

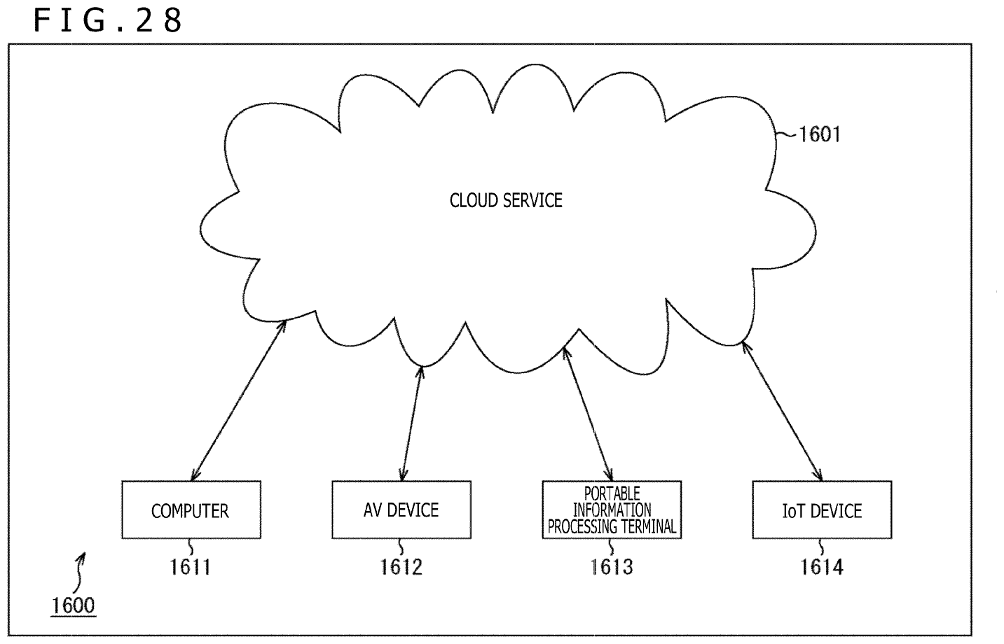

In addition, the present technique can also be applied to a network system including a plurality of apparatuses. FIG. 28 illustrates an example of a schematic configuration of the network system according to the present technique.

A network system 1600 illustrated in FIG. 28 is a system in which devices transfer information regarding images (moving images) through a network. A cloud service 1601 of the network system 1600 is a system that provides services regarding images (moving images) to terminals, such as a computer 1611, an AV (Audio Visual) device 1612, a portable information processing terminal 1613, and an IoT (Internet of Things) device 1614, connected to and capable of communicating with the cloud service 1601. For example, the cloud service 1601 provides the terminals with supply services of content of images (moving images) such as so-called video distribution (on-demand or live broadcasting). In addition, the cloud service 1601 provides, for example, a backup service for receiving and storing content of images (moving images) from the terminals. In addition, the cloud service 1601 provides, for example, a service for mediating transfer of content of images (moving images) between the terminals.

The physical configuration of the cloud service 1601 is arbitrary. For example, the cloud service 1601 may include various servers, such as a server that saves and manages moving images, a server that distributes moving images to the terminals, a server that acquires moving images from the terminals, and a server that manages users (terminals) and charges, and an arbitrary network, such as the Internet and a LAN.

The computer 1611 includes, for example, an information processing apparatus, such as a personal computer, a server, and a workstation. The AV device 1612 includes, for example, an image processing apparatus, such as a television receiver, a hard disk recorder, a gaming device, and a camera. The portable information processing terminal 1613 includes, for example, a portable information processing apparatus, such as a notebook personal computer, a tablet terminal, a mobile phone, and a smartphone. The IoT device 1614 includes an arbitrary object that executes a process regarding images, such as a machine, a home appliance, furniture, other objects, an IC tag, and a card-type device. The terminals have communication functions, and the terminals can connect to (establish sessions with) the cloud service 1601 to transfer information (that is, communicate) with the cloud service 1601. In addition, each terminal can also communicate with the other terminals. The terminals may communicate through the cloud service 1601 or may communicate without the cloud service 1601.

The present technique may be applied to the network system 1600, and in the transfer of data of images (moving images) between the terminals or between a terminal and the cloud service 1601, the image data may be encoded as described in each embodiment. That is, each of the terminals (from the computer 1611 to the IoT device 1614) and the cloud service 1601 may have one of or both the function of the image encoding apparatus 100 and the function of the image decoding apparatus 200. In this way, the terminals (from the computer 1611 to the IoT device 1614) and the cloud service 1601 that transfer the image data can obtain advantageous effects similar to the advantageous effects of the embodiments.

### <Etc.>

Note that various types of information regarding encoded data (bitstream) may be transmitted or recorded after multiplexing the information with the encoded data, or the information may be transmitted or recorded as separate data associated with the encoded data without multiplexing the information with the encoded data. Here, the term “associated” means, for example, that one piece of data can be used (can be linked) during processing of another piece of data. That is, the data associated with each other may be integrated as one piece of data or may be provided as separate pieces of data. For example, the information associated with the encoded data (image) may be transmitted on a transmission path different from the encoded data (image). In addition, for example, the information associated with the encoded data (image) may be recorded in a recording medium separate from the encoded data (image) (or in a separate recording area of the same recording medium). Note that part of the data may be “associated,” instead of the entire data. For example, the image and the information corresponding to the image may be associated with each other in an arbitrary unit, such as a plurality of frames, one frame, and part of the frame.

In addition, as described above, the terms, such as “combine,” “multiplex,” “add,” “integrate,” “include,” “store,” “put in,” “place into,” and “insert,” in the present specification denote grouping of a plurality of things, such as grouping of encoded data and metadata, and each term denotes one method of “associating” described above.

In addition, the embodiments of the present technique are not limited to the embodiments described above, and various changes can be made without departing from the scope of the present technique.

For example, the system in the present specification denotes a set of a plurality of constituent elements (apparatuses, modules (components), and the like), and whether or not all of the constituent elements are in the same housing does not matter. Therefore, a plurality of apparatuses stored in separate housings and connected through a network and one apparatus storing a plurality of modules in one housing are both systems.

Furthermore, for example, the configuration of one apparatus (or processing unit) described above may be divided to provide a plurality of apparatuses (or processing units). Conversely, the configurations of a plurality of apparatuses (or processing units) described above may be put together to provide one apparatus (or processing unit). In addition, configurations other than the configurations described above may be obviously added to the configuration of each apparatus (or each processing unit). Furthermore, part of the configuration of an apparatus (or processing unit) may be included in the configuration of another apparatus (or another processing unit) as long as the configuration and the operation of the entire system are substantially the same.

In addition, the present technique can be provided as, for example, cloud computing in which a plurality of apparatuses share one function and cooperate to execute a process through a network.

In addition, the program described above can be executed by, for example, an arbitrary apparatus. In that case, the apparatus can have necessary functions (such as functional blocks) and obtain necessary information.

In addition, for example, one apparatus can execute each step described in the flow charts, or a plurality of apparatuses can take charge and execute each step. Furthermore, in the case where one step includes a plurality of processes, one apparatus can execute the plurality of processes included in one step, or a plurality of apparatuses can take charge and execute the processes.

Note that the program executed by the computer may be a program in which the processes of the steps describing the program are executed in chronological order described in the present specification, or the program may be a program for executing the processes in parallel or for executing the processes separately at a necessary timing such as when the processes are invoked. Furthermore, the processes of the steps describing the program may be executed in parallel with processes of other programs or may be executed in combination with processes of other programs.

Note that the plurality of present techniques described in the present specification can be independently and separately implemented as long as there is no contradiction. Obviously, a plurality of arbitrary present techniques can be combined and implemented. For example, the present technique described in one of the embodiments can also be implemented in combination with the present technique described in another embodiment. In addition, an arbitrary present technique described above can also be implemented in combination with another technique not described above.

Note that the present technique can also be configured as follows.
(1)

An image processing apparatus including:

a rearrangement unit that rearranges fields in each GOP (Group Of Picture) of interlaced images input in a reproduction order to arrange the fields in a decoding order in order of an I picture, a leading picture that precedes the I picture in the reproduction order, and a trailing picture that follows the I picture in the reproduction order; and

an encoding unit that encodes the fields rearranged in the decoding order by the rearrangement unit.
(2)

The image processing apparatus according to (1), in which

the rearrangement unit rearranges a P picture of a bottom field paired with the I picture of a top field in the reproduction order such that the P picture follows the leading picture.
(3)

The image processing apparatus according to (1) or (2), further including:

a setting unit that sets nal_unit_type of each of the fields.
(4)

The image processing apparatus according to (3), in which

the setting unit sets the I picture as a trailing picture in a second or subsequent GOP.
(5)

The image processing apparatus according to (3) or (4), in which

the setting unit sets the I picture in a bottom field, sets the P picture, which follows the I picture in the decoding order, in a top field paired with the I picture, and sets the P picture as a leading picture in a second or subsequent GOP.
(6)

The image processing apparatus according to any one of (1) to (5), in which

the rearrangement unit eliminates the leading picture of a second or subsequent GOP when the rearrangement unit rearranges the fields in the decoding order.
(7)

The image processing apparatus according to any one of (1) to (6), further including:

an orthogonal transformation unit that performs an orthogonal transformation of the fields rearranged in the decoding order by the rearrangement unit; and

a quantization unit that quantizes an orthogonal transformation coefficient obtained by the orthogonal transformation unit, in which

the encoding unit is configured to encode a quantization coefficient obtained by the quantization unit.
(8)

The image processing apparatus according to (7), further including:

a prediction unit that generates a predicted image of the fields; and

a computation unit that subtracts the predicted image generated by the prediction unit from the fields rearranged in the decoding order by the rearrangement unit to generate residual data, in which

the orthogonal transformation unit is configured to perform an orthogonal transformation of the residual data obtained by the computation unit.
(9)

The image processing apparatus according to any one of (1) to (8), in which

the rearrangement unit and the encoding unit use methods in compliance with ITU-T H.265|ISO/IEC 23008-2 High Efficiency Video Coding to execute the respective processes.
(10)

An image processing method including:

rearranging fields in each GOP (Group Of Picture) of interlaced images input in a reproduction order to arrange the fields in a decoding order in order of an I picture, a leading picture that precedes the I picture in the reproduction order, and a trailing picture that follows the I picture in the reproduction order; and

encoding the fields rearranged in the decoding order.
(11)

An image processing apparatus including:

a setting unit that sets nal_unit_type of each of fields in each GOP (Group Of Picture) of interlaced images input in a reproduction order, sets an I picture in a bottom field, sets a P picture, which follows the I picture in a decoding order, in a top field paired with the I picture, and sets the P picture as a leading picture; and

an encoding unit that encodes each of the fields provided with the nal_unit_type set by the setting unit.
(12)

The image processing apparatus according to (11), in which

the setting unit sets the nal_unit_type of the I picture to IDR_W_RADL or CRA_NUT and sets the nal_unit_type of the P picture to RADL_N.
(13)

The image processing apparatus according to (11) or (12), in which

the setting unit sets the I picture in a top field in a second or subsequent GOP, sets the P picture, which follows the I picture in the decoding order, in a bottom field paired with the I picture, and sets the I picture and the P picture as trailing pictures.
(14)

The image processing apparatus according to any one of (11) to (13), further including:

a rearrangement unit that rearranges, in the decoding order, each of the fields in the reproduction order provided with the nal_unit_type set by the setting unit, in which the encoding unit is configured to encode the fields rearranged in the decoding order by the rearrangement unit.
(15)

The image processing apparatus according to (14), in which

the setting unit sets the I picture in a top field in a second or subsequent GOP, sets the P picture, which follows the I picture in the decoding order, in a bottom field paired with the I picture, and sets the I picture as a trailing picture, and

the rearrangement unit rearranges the P picture of the bottom field paired with the I picture of the top field in the reproduction order such that the P picture follows the leading picture in a second or subsequent GOP.
(16)

The image processing apparatus according to any one of (11) to (15), in which

the rearrangement unit eliminates the leading picture of a second or subsequent GOP when the rearrangement unit rearranges the fields in the decoding order.
(17)

The image processing apparatus according to any one of (11) to (16), further including:

an orthogonal transformation unit that performs an orthogonal transformation of each of the fields provided with the nal_unit_type set by the setting unit; and

a quantization unit that quantizes an orthogonal transformation coefficient obtained by the orthogonal transformation unit, in which

the encoding unit is configured to encode a quantization coefficient obtained by the quantization unit.
(18)

The image processing apparatus according to (17), further including:

a prediction unit that generates a predicted image of the fields; and

a computation unit that subtracts the predicted image generated by the prediction unit from the fields provided with the nal_unit_type set by the setting unit to generate residual data, in which

the orthogonal transformation unit is configured to perform an orthogonal transformation of the residual data obtained by the computation unit.
(19)

The image processing apparatus according to any one of (11) to (18), in which

the setting unit and the encoding unit use methods in compliance with ITU-T H.265|ISO/IEC 23008-2 High Efficiency Video Coding to execute the respective processes.
(20)

An image processing method including:

setting nal_unit_type of each of fields in each GOP (Group Of Picture) of interlaced images input in a reproduction order, setting an I picture in a bottom field, setting a P picture, which follows the I picture in a decoding order, in a top field paired with the I picture, and setting the P picture as a leading picture; and

encoding each of the fields provided with the nal_unit_type.
(21)

An image processing apparatus including:

a rearrangement unit that rearranges fields in each GOP (Group Of Picture) of interlaced images input in a reproduction order to arrange the fields in a decoding order in which a leading picture that precedes an I picture in the reproduction order is eliminated; and

an encoding unit that encodes the fields rearranged in the decoding order by the rearrangement unit.
(22)

The image processing apparatus according to (21), in which

the rearrangement unit eliminates four fields that precede the I picture in the reproduction order when the rearrangement unit rearranges the fields in the decoding order.
(23)

The image processing apparatus according to (21) or (22), further including:

a setting unit that sets nal_unit_type of each of the fields.
(24)

The image processing apparatus according to (23), in which the setting unit sets the I picture as a trailing picture in a second or subsequent GOP.
(25)

The image processing apparatus according to (23) or (24), in which

the setting unit sets the I picture in a bottom field, sets the P picture, which follows the I picture in the decoding order, in a top field paired with the I picture, and sets the P picture as a leading picture in a second or subsequent GOP.
(26)

The image processing apparatus according to any one of (21) to (25), in which

the rearrangement unit rearranges the P picture of a bottom field paired with the I picture in a top field in the reproduction order in a second or subsequent GOP such that the P picture follows a leading picture that precedes the I picture in the reproduction order.
(27)

The image processing apparatus according to any one of (21) to (26), further including:

an orthogonal transformation unit that performs an orthogonal transformation of the fields rearranged in the decoding order by the rearrangement unit; and

a quantization unit that quantizes an orthogonal transformation coefficient obtained by the orthogonal transformation unit, in which

the encoding unit is configured to encode a quantization coefficient obtained by the quantization unit.
(28)

The image processing apparatus according to (27), further including:

a prediction unit that generates a predicted image of the fields; and

a computation unit that subtracts the predicted image generated by the prediction unit from the fields rearranged in the decoding order by the rearrangement unit to generate residual data, in which

the orthogonal transformation unit is configured to perform an orthogonal transformation of the residual data obtained by the computation unit.
(29)

The image processing apparatus according to any one of (21) to (28), in which

the rearrangement unit and the encoding unit use methods in compliance with ITU-T H.265|ISO/IEC 23008-2 High Efficiency Video Coding to execute the respective processes.
(30)

An image processing method including:

rearranging fields in each GOP (Group Of Picture) of interlaced images input in a reproduction order to arrange the fields in a decoding order in which a leading picture that precedes an I picture in the reproduction order is eliminated; and

encoding the fields rearranged in the decoding order.
(31)

An image processing apparatus including:

a setting unit that sets nal_unit_type of each of fields in each GOP (Group Of Picture) of interlaced images input in a reproduction order and that sets, for a P picture of a field paired with an I picture, nal_unit_type indicative of a picture paired with the I picture; and

an encoding unit that encodes each of the fields provided with the nal_unit_type set by the setting unit.
(32)

The image processing apparatus according to (31), in which

the setting unit sets the nal_unit_type of a P picture of a field paired with an IDR picture to IDR_PAIR_W_RADL or IDR_PAIR_N_LP.
(33)

The image processing apparatus according to (31) or (32), in which

the setting unit sets the nal_unit_type of a P picture of a field paired with a CRA picture to CRA_PAIR_NUT.
(34)

The image processing apparatus according to any one of (31) to (33), in which

the setting unit sets the nal_unit_type of a P picture of a field paired with a BLA picture to BLA_PAIR_W_LP, BLA_PAIR_W_RADL, or BLA_PAIR_N_LP.
(35)

The image processing apparatus according to any one of (31) to (34), further including:

a rearrangement unit that rearranges, in a decoding order, each of the fields in the reproduction order provided with the nal_unit_type set by the setting unit, in which

the encoding unit is configured to encode the fields rearranged in the decoding order by the rearrangement unit.
(36)

The image processing apparatus according to (35), in which

the rearrangement unit rearranges the P picture provided with the nal_unit_type indicative of the picture paired with the I picture set by the setting unit such that the P picture precedes the leading picture that precedes the I picture in the reproduction order.
(37)

The image processing apparatus according to any one of (31) to (36), further including:

an orthogonal transformation unit that performs an orthogonal transformation of each of the fields provided with the nal_unit_type set by the setting unit; and

a quantization unit that quantizes an orthogonal transformation coefficient obtained by the orthogonal transformation unit, in which

the encoding unit is configured to encode a quantization coefficient obtained by the quantization unit.
(38)

The image processing apparatus according to (37), further including:

a prediction unit that generates a predicted image of the fields; and

a computation unit that subtracts the predicted image generated by the prediction unit from the fields provided with the nal_unit_type set by the setting unit to generate residual data, in which

the orthogonal transformation unit is configured to perform an orthogonal transformation of the residual data obtained by the computation unit.
(39)

The image processing apparatus according to any one of (31) to (38), in which

the setting unit and the encoding unit use methods in compliance with ITU-T H.265|ISO/IEC 23008-2 High Efficiency Video Coding to execute the respective processes.
(40)

An image processing method including:

setting nal_unit_type of each of fields in each GOP (Group Of Picture) of interlaced images input in a reproduction order and setting, for a P picture of a field paired with an I picture, nal_unit_type indicative of a picture paired with the I picture; and

encoding each of the fields provided with the nal_unit_type.
(41)

An image processing apparatus including:

a decoding unit that decodes a bitstream in which fields of interlaced images in a decoding order are encoded and that refers to an I picture to decode a P picture provided with nal_unit_type indicative of a picture paired with the I picture in each GOP (Group Of Picture); and

a rearrangement unit that rearranges the fields obtained by the decoding unit in a reproduction order and that rearranges the P picture to arrange the P picture in a field paired with the I picture.
(42)

The image processing apparatus according to (41), in which

the nal_unit_type of a P picture of a field paired with an IDR picture is set to IDR_PAIR_W_RADL or IDR_PAIR_N_LP.
(43)

The image processing apparatus according to (41) or (42), in which

the nal_unit_type of a P picture of a field paired with a CRA picture is set to CRA_PAIR_NUT.
(44)

The image processing apparatus according to any one of (41) to (43), in which

the nal_unit_type of a P picture of a field paired with a BLA picture is set to BLA_PAIR_W_LP, BLA_PAIR_W_RADL, or BLA_PAIR_N_LP.
(45)

An image processing method including:

decoding a bitstream in which fields of interlaced images in a decoding order are encoded and referring to an I picture to decode a P picture provided with nal_unit_type indicative of a picture paired with the I picture in each GOP (Group Of Picture); and

rearranging the obtained fields in a reproduction order and rearranging the P picture to arrange the P picture in a field paired with the I picture.

### REFERENCE SIGNS LIST

100 Image encoding apparatus, 110 Preprocessing unit, 111 Preprocessing buffer, 115 Encoding unit, 131 Information acquisition unit, 132 NAL_UNIT_TYPE setting unit, 133 Rearrangement unit, 200 Image decoding apparatus, 212 Decoding unit, 217 Rearrangement buffer, 230 Rearrangement unit

1. An image processing apparatus comprising:
a rearrangement unit that rearranges fields in each GOP (Group Of Picture) of interlaced images input in a reproduction order to arrange the fields in a decoding order in order of an I picture, a leading picture that precedes the I picture in the reproduction order, and a trailing picture that follows the I picture in the reproduction order; and
an encoding unit that encodes the fields rearranged in the decoding order by the rearrangement unit.

2. The image processing apparatus according to claim 1, wherein
the rearrangement unit rearranges a P picture of a bottom field paired with the I picture of a top field in the reproduction order such that the P picture follows the leading picture.

3. The image processing apparatus according to claim 1, further comprising:
a setting unit that sets nal_unit_type of each of the fields.

4. The image processing apparatus according to claim 3, wherein
the setting unit sets the I picture as a trailing picture in a second or subsequent GOP.

5. The image processing apparatus according to claim 3, wherein
the setting unit sets the I picture in a bottom field, sets the P picture, which follows the I picture in the decoding order, in a top field paired with the I picture, and sets the P picture as a leading picture in a second or subsequent GOP.

6. The image processing apparatus according to claim 1, wherein
the rearrangement unit eliminates the leading picture of a second or subsequent GOP when the rearrangement unit rearranges the fields in the decoding order.

7. The image processing apparatus according to claim 1, further comprising:
an orthogonal transformation unit that performs an orthogonal transformation of the fields rearranged in the decoding order by the rearrangement unit; and
a quantization unit that quantizes an orthogonal transformation coefficient obtained by the orthogonal transformation unit, wherein
the encoding unit is configured to encode a quantization coefficient obtained by the quantization unit.

8. The image processing apparatus according to claim 7, further comprising:
a prediction unit that generates a predicted image of the fields; and
a computation unit that subtracts the predicted image generated by the prediction unit from the fields rearranged in the decoding order by the rearrangement unit to generate residual data, wherein
the orthogonal transformation unit is configured to perform an orthogonal transformation of the residual data obtained by the computation unit.

9. The image processing apparatus according to claim 1, wherein
the rearrangement unit and the encoding unit use methods in compliance with ITU-T H.265|ISO/IEC 23008-2 High Efficiency Video Coding to execute the respective processes.

10. An image processing method comprising:
rearranging fields in each GOP (Group Of Picture) of interlaced images input in a reproduction order to arrange the fields in a decoding order in order of an I picture, a leading picture that precedes the I picture in the reproduction order, and a trailing picture that follows the I picture in the reproduction order; and
encoding the fields rearranged in the decoding order.

11. An image processing apparatus comprising:
a setting unit that sets nal_unit_type of each of fields in each GOP (Group Of Picture) of interlaced images input in a reproduction order and that sets, for a P picture of a field paired with an I picture, nal_unit_type indicative of a picture paired with the I picture; and
an encoding unit that encodes each of the fields provided with the nal_unit_type set by the setting unit.

12. The image processing apparatus according to claim 11, wherein
the setting unit sets the nal_unit_type of a P picture of a field paired with an IDR picture to IDR_PAIR_W_RADL or IDR_PAIR_N_LP.

13. The image processing apparatus according to claim 11, wherein
the setting unit sets the nal_unit_type of a P picture of a field paired with a CRA picture to CRA_PAIR_NUT.

14. The image processing apparatus according to claim 11, wherein
the setting unit sets the nal_unit_type of a P picture of a field paired with a BLA picture to BLA_PAIR_W_LP, BLA_PAIR_W_RADL, or BLA_PAIR_N_LP.

15. The image processing apparatus according to claim 11, further comprising:
a rearrangement unit that rearranges, in a decoding order, each of the fields in the reproduction order provided with the nal_unit_type set by the setting unit, wherein
the encoding unit is configured to encode the fields rearranged in the decoding order by the rearrangement unit.

16. The image processing apparatus according to claim 15, wherein
the rearrangement unit rearranges the P picture provided with the nal_unit_type indicative of the picture paired with the I picture set by the setting unit such that the P picture precedes the leading picture that precedes the I picture in the reproduction order.

17. The image processing apparatus according to claim 11, further comprising:
an orthogonal transformation unit that performs an orthogonal transformation of each of the fields provided with the nal_unit_type set by the setting unit; and
a quantization unit that quantizes an orthogonal transformation coefficient obtained by the orthogonal transformation unit, wherein
the encoding unit is configured to encode a quantization coefficient obtained by the quantization unit.

18. The image processing apparatus according to claim 17, further comprising:
a prediction unit that generates a predicted image of the fields; and
a computation unit that subtracts the predicted image generated by the prediction unit from the fields provided with the nal_unit_type set by the setting unit to generate residual data, wherein
the orthogonal transformation unit is configured to perform an orthogonal transformation of the residual data obtained by the computation unit.

19. The image processing apparatus according to claim 11, wherein
the setting unit and the encoding unit use methods in compliance with ITU-T H.265|ISO/IEC 23008-2 High Efficiency Video Coding to execute the respective processes.

20. An image processing method comprising:
setting nal_unit_type of each of fields in each GOP (Group Of Picture) of interlaced images input in a reproduction order and setting, for a P picture of a field paired with an I picture, nal_unit_type indicative of a picture paired with the I picture; and
encoding each of the fields provided with the nal_unit_type.
